(19) United States
(12) Patent Application Publication
(10) Pub. No.: US 2008/0182773 A1
(43) Pub. Date: Jul. 31, 2008

(54) Thickeners Based on Polymers Comprising Amine Groups

(75) Inventors: Werner Gauweiler, Lustadt (DE); Volker Braig, Weinheim-Lutzelsachsen (DE); Ivette Garcia Castro, Ludwigshafen Gartenstadt (DE); Son Nguyen-Kim, Hemsbach (DE); Matthias Laubender, Schifferstadt (DE); Marcus Guzmann, Muhlhausen (DE); Olga Pinneker, Hessheim (DE)

Correspondence Address: CONNOLLY BOVE LODGE & HUTZ LLP, 1875 EYE STREET, N.W., SUITE 1100, WASHINGTON, DC, 20036, US

(73) Assignee: BASF Aktiengesellschaft, Ludwigshafen (DE)

(21) Appl. No.: 11/909,181

(22) PCT Filed: Mar. 23, 2006
(86) PCT No.: PCT/EP2006/061009

§ 371 Date: Sep. 20, 2007

(30) Foreign Application Priority Data
Mar. 24, 2005 (DE) 10 2005 014 293.1

(51) Int. Cl. C11D 3/37; C08G 73/00; C08L 77/00; C08L 39/04

(52) U.S. Cl. 510/475; 525/418; 525/55

(57) ABSTRACT

The invention relates to the use of mixtures of polymers comprising amine groups and polymers comprising amide groups for modifying the rheology of compositions comprising water, and to rheology modifying methods. In particular, the invention relates to the use of these mixtures for the thickening of compositions comprising water for cosmetic, human and animal nutrition, dermatology, pharmacy and detergents and cleaners, crop protection, surface modification and during petroleum production, such as, for example, enhanced oil recovery.

The invention relates to the use of mixtures of polymers comprising amine groups and polymers comprising amide groups for modifying the rheology of compositions comprising water, and to rheology modifying methods. In particular, the invention relates to the use of these mixtures for the thickening of compositions comprising water for cosmetic, human and animal nutrition, dermatology, pharmacy and detergents and cleaners, crop protection, surface modification and during petroleum production, such as, for example, enhanced oil recovery.

Thickeners are used widely for increasing the viscosity of aqueous preparations, for example in the fields of cosmetics, human and animal nutrition, pharmacy and for detergents.

Examples of thickeners which are often used are fatty acid polyethylene glycol monoesters, fatty acid polyethylene glycol diesters, fatty acid alkanolamides, oxethylated fatty alcohols, ethoxylated glycerol fatty acid esters, cellulose ethers, sodium alginate, polyacrylic acids (for example Carbopol®) and neutral salts.

However, the use of the known thickeners is associated with disadvantages, depending on the preparation to be thickened. For example, the thickening effect and the salt stability of the thickener may be unsatisfactory and its incorporation into the preparation to be thickened may be hindered. For example, it is known that crosslinked (hydrophobically modified) polyacrylic acids in the neutralized state react very sensitively to salt. The addition of salt leads to an abrupt and drastic lowering of the viscosity. For this reason, it is unusual to use these polymers in shampoo formulations as viscosity-imparting agents. Due to the salt concentrations present therein (surfactants, surfactant mixtures, NaCl as impurity in surfactants) it is not possible to bring about a significant increase in viscosity. The presence of cationic auxiliaries results in complexation and precipitation.

### PRIOR ART

U.S. Pat. No. 3,915,921 (The B.F. Goodrich Company) describes copolymers of 95-50% by weight of monoethylenically unsaturated carboxylic acids and 5-50% by weight of an acrylic or methacrylic ester of a C10-C30 fatty alcohol. Optionally, the polymers may be crosslinked. The copolymers are used as thickeners for dentifrices and printing pastes.

EP-A 0 268 164 (The B.F. Goodrich Company) describes the use of crosslinked copolymers of monoolefinically unsaturated acids (50-99% by weight) and alkyl esters of monoolefinically unsaturated acids (50-1% by weight) (crosslinked with pentaerythritol triallyl ether) which are known under the CTFA name “Acrylates/C₁₀₋₃₀-Alkyl Acrylate Crosspolymer”. These are used for stabilizing O/W emulsions in cosmetic and pharmaceutical preparations, such as, for example, skin creams, skin lotions and gels.

In WO 97/21744 (BASF Aktiengesellschaft), crosslinked copolymers are used. These polymers are precipitation polymers and constituted free-flowing powders which are neutralized after being stirred into water. This neutralization step is necessary to convert the acidic polymers into the carboxylates, which are ultimately responsible for the viscosity.

EP-A 0 128 237 (The B.F. Goodrich Company) describes weakly crosslinked copolymers (0.1 to 1.0% by weight) of monoethylenically unsaturated carboxylic acids (95.5 to 98.9% by weight) and esters of these carboxylic acids (1 to 2.5% by weight) for the use as thickener in a printing paste,

U.S. Pat. No. 4,432,881 (Dow Chemical Company) describes copolymers of water-soluble monomers, such as, for example, acrylamide, acrylic acid etc., preferably the combinations thereof, and N-alkylacrylamides and acrylic esters. The hydrophilic/hydrophobic fraction ratios are 98:2 mol % to 99.995:0.005 mol %, preferably 99:1 mol % to 99.9:0.1 mol %. Molecular weights are given between 2*10⁵ to 5 million g/mol, preferably between 8*10⁵−2.5 million g/mol. Use is made of the resulting polymers as dispersible hydrophobic thickeners, used in formulations comprising the described polymers, a nonionic surface-active substance (HLB 2-15) and an inorganic salt for increasing the viscosity of water.

U.S. Pat. NO. 4,395,524 (Rohm and Haas Company) describes the copolymerization of hydrophilic components (e.g. acrylamide, acrylic acid, N-vinylpyrrolidone etc.) with N-alkylacrylamides (alkyl=C10 to C36, preferably C12 to C22). The copolymerization is carried out as precipitation polymerization or polymerization in solution. The molecular weight of the described polymers is M_{w}>30 000 g/mol. The polymers thus obtained are used as thickeners of aqueous systems, sedimentation stabilizers, surface-active substances or dispersants.

JP 11228704 (Kurita Water Ind. Ltd.) describes the liquid dispersions which comprise polymers comprising vinylamine groups, polymers comprising vinylpyrrolidone units and mineral salts and also the use thereof as flocculating agents for wastewater, for the removal of water from sewage sludge and as a paper additive.

WO 01153359 (ISP Investments Inc.) describes crosslinked gels comprising complexes of polyvinyllactams and linear polyethyleneimine. These gels are insoluble in water and can be used as a matrix for the delayed release (slow-release effect) of active ingredients in skin care and hair care preparations, and also as a thickener or hydrogel. EP-A 0 627 217 (Helene Curtis Inc.) describes shampoo preparations comprising polyethyleneimine which further comprise polyvinylpyrrolidone as emulsion stabilizer. The use of mixtures of polyethyleneimine and polyvinylpyrrolidone as thickener is not described.

U.S. Pat. No. 6,365,664 (Hydromer Inc.) describes hydrophilic, stable, irreversible gels comprising a polyaldehyde and a second, water-soluble polymer which comprises amine groups. The polyaldehyde is obtained by grafting (meth)acrolein onto polyvinylpyrrolidone or polyethylene glycol.

U.S. Pat. No. 5,645,855 (Ridge Scientific Enterprises Inc.) describes a composition comprising a crosslinked salt of
a) a polyvinylpyrrolidone which is partially ring-opened,
b) at least one polymer comprising (meth)acrylic acid
c) an amine-containing polymer.

The weight ratio of polyvinylpyrrolidone to the amine-containing polymer is in the range from 40:1 to 150:1. The composition is used as pressure-sensitive adhesive.

DE 102 41 296 A1 (BASF) describes the use of cationic crosslinked polymers preparable by free-radical polymerization in the presence of salts and of protective colloids in cosmetics. The cationic crosslinked polymers described are, for example, copolymers of vinylpyrrolidone and quaternized vinylimidazole, which are prepared using vinylamine-acrylic acid copolymers as protective colloids.

DE 198 51 024 A1 (BASF) describes aqueous dispersions of water-soluble polymers of N-vinylformamide and/or of N-vinylacetamide which, based on 100 parts by weight of water, comprise

(A) 5 to 80 parts by weight of a water-soluble polymer comprising N-vinylformamide and/or N-vinylacetamide units having particle sizes of from 50 nm to 2 micrometers and

(B) 1 to 50 parts by weight of at least one polymeric dispersant which is incompatible with the water-soluble polymers (A) in aqueous solution. The polymeric dispersant used is, for example, polyvinylpyrrolidone. The aqueous dispersions are used as dewatering, flocculation and retention agents, and as wet and dry strength agents and as fixing agents in the manufacture of paper.

DE 197 10 215 A1 (BASF) describes finely divided homopolymers and copolymers of polymers comprising N-vinylformamide and, if appropriate, vinylamine units by free-radical polymerization of N-vinylformamide and, if appropriate, comonomers in a solution of the monomers and, if appropriate, subsequent hydrolysis to polymers comprising vinylamine units. The polymerization is carried out in the presence of poiyvinylpyrrolidone as protective colloid. A use for modifying rheology is not described.

Problem and Solution

An object of the invention is to provide an agent for modifying the rheology of compositions comprising water for cosmetics, human and animal nutrition, dermatology, pharmacy and detergents and cleaners which can be incorporated into these preparations without problems.

The resulting rheology-modified, in particular thickened preparations should here, as far as possible, be clear, stable and, depending on the field of use, if appropriate water-soluble.

The rheology modification, in particular the thickening effect, should also be possible in the presence of organic solvents in the preparations comprising water.

In addition, it should be possible to be able to dispense with crosslinked polymers as rheology modifiers. The rheology-modified effect should be present over the largest possible pH range, this effect being particularly desirable in acceptable pH ranges from pH 6 to 9 for cosmetic and/or pharmaceutical preparations.

In addition, the compositions should be suitable for producing cut-resistant, water-soluble gels and for producing active ingredient compositions with delayed active ingredient release (slow release effect).

The rheology-modifying effect should also be retained in the presence of salts, polyelectrolytes or charged, i.e. anionic, cationic, betainic or amphoteric, polymers in the preparations comprising water.

These objects are achieved through the use of
a) a mixture of
   i) at least one polymer comprising amide groups and
   ii) at least one further polymer chosen from the group consisting of
      (ii1) polymers which comprise branched polyethyleneimine structures,
      (ii2) polymers comprising amino groups different from (iil) and linear polyethyleneimines and
      (ii3) mixtures of (ii1) and (ii2),
      where the weight ratio of the sum of the monomer building blocks of polymer i) carrying the amide groups to the sum of the monomer building blocks of polymer ii2) carrying the amino groups is in the range less than 27:1 to 1:30 or
b) at least one polymer comprising amide and amino groups, where the quantitative ratio of amide groups to amino groups is in the range from 20:1 to 1:20,
   with the proviso that i) comprises less than 0.49% by weight of acrolein based on the total weight of i) in copolymerized and/or grafted form, for modifying the rheology of compositions comprising water.

The compositions comprising water may, for example, be solutions, emulsions, suspensions or dispersions.

Mixture a) means that the components i) and ii) are present together in the composition comprising water to be modified with regard to its rheology. To produce this mixture, the components i) and ii) can be added to the composition in the already mixed state. However, the mixture can, for example, also only be produced in the composition comprising water. In addition, the components i) and ii) can be added to the composition comprising water simultaneously or not simultaneously. One of the components i) or ii) can also be prepared in the composition comprising water in the presence or absence of the other component in each case. If the other component in each case is absent during the preparation, then it is added following the preparation for the purpose of producing the mixture.

Modification of the Rheological Properties

Modification of the rheological properties is understood quite generally as meaning the change in the deformation behavior and flow behavior of mailer. The most important rheological properties are viscosity, thixotropy, structural viscosity, rheopexy and dilatancy. These terms are known to the person skilled in the art.

Viscosity is usually understood as meaning the “ropiness” of a liquid. It results from the intermolecular forces in a liquid, and is thus dependent on cohesion (intramolecular) and adhesion (intermolecular). The viscosity characterizes the flow behavior of a liquid. High viscosity means thick-liquid, whereas low viscosity means thin-liquid.

Thixotropy is usually understood as meaning the property of a fluid to exhibit a lower viscosity after shearing and to build up the original viscosity when motionless.

Rheopexy is usually understood as meaning the property of a fluid to exhibit a higher viscosity after shearing. This behavior is closely related to the dilatancy, in the case of which the viscosity is higher only during shearing.

Modification of the rheology is, in particular, the increase in the viscosity of liquids, usually also referred to as “thickening”. This viscosity increase can extend to the formation of gels or solids.

Polymers i) and b)

Suitable polymers i) are generally all polymers which comprise amide groups. The amide groups can be parts of the polymer main and/or side chains. Suitable polymers b) are generally all polymers which simultaneously comprise amino and amide groups.

In principle, the polymers i) and b) can be produced by incorporating suitable monomers by polymerization or by reacting an already existing polymer (polymer-analogous reaction).

Preferred polymers i) and b) are polymers which comprise α,β-ethylenically unsaturated amide group-containing compounds of the general formula I in copolymerized form

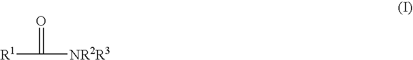

where

R¹ is a group of the formula CH₂═CR⁴ where R⁴═H or C₁-C₄-alkyl and R² and R³, independently of one another, are H, alkyl, cycloalkyl, heterocycloalkyl, aryl or hetaryl,

or R² and R³ together with the nitrogen atom to which they are bonded are a five- to eight-membered nitrogen heterocycle,

or R² is a group of the formula CH₂═CR⁴— and R¹ and R³, independently of one another, are H, alkyl, cycloalkyl, heterocycloalkyl, aryl or hetaryl, or R¹ and R³ together with the amide group to which they are bonded are a lactam having 5 to 8 ring atoms.

Within the scope of the present invention, the expression alkyl comprises straight-chain and branched alkyl groups. Suitable short-chain alkyl groups are, for example, straight-chain or branched C1-C7-alkyl groups, preferably C1-C6-alkyl groups and particularly preferably C1-C4-alkyl groups. These include, in particular, methyl, ethyl, propyl, isopropyl, n-butyl, 2-butyl, sec-butyl, tert-butyl, n-pentyl, 2-pentyl, 2-methylbutyl, 3-methylbutyl, 1,2-dimethylpropyl, 1,1-dimethylpropyl, 2,2-dimethylpropyl, 1-ethylpropyl, n-hexyl, 2-hexyl, 2-methylpentyl, 3-methylpentyl, 4-methylpentyl, 1,2-dimethylbutyl, 1,3-dimethylbutyl, 2,3-dimethylbutyl, 1,1-dimethylbutyl, 2,2-dimethylbutyl, 3,3-dimethylbutyl, 1,1,2-trimethylpropyl, 1,2,2-trimethylpropyl, 1-ethylbutyl, 2-ethylbutyl, 1-ethyl-2-methylpropyl, n-heptyl, 2-heptyl, 3-heptyl, 2-ethylpentyl, 1-propylbutyl, octyl etc.

Suitable longer-chain C8-C30-alkyl and C8-C30-alkenyl groups are straight-chain and branched alkyl and alkenyl groups. Preference is given here to predominantly linear alkyl radicals as also occur in natural or synthetic fatty acids and fatty alcohols, and oxo alcohols, which may, if appropriate, additionally be mono-, di- or polyunsaturated. These include, for example, n-hexyl(ene), n-heptyl(ene), n-octyl(ene), n-nonyl(ene), n-decyl(ene), n-undecyl(ene), n-dodecyl(ene), n-tridecyl(ene), n-etradecyl(ene), n-pentadecyl(ene), n-hexadecyl(ene), n-heptadecyl(ene), n-octadecyl(ene), n-nonadecyl(ene) etc.

Cycloalkyl is preferably C5-C8-cycloalkyl, such as cyclopentyl, cyclohexyl, cycloheptyl or cyclooctyl.

For the purposes of the present invention, the expression heterocycloalkyl comprises saturated, cycloaliphatic groups having in general 4 to 7, preferably 5 or 6, ring atoms in which 1 or 2 of the ring carbon atoms are replaced by heteroatoms chosen from the elements oxygen, nitrogen and sulfur and which may be optionally substituted, where in the case of a substitution, these heterocycloaliphatic groups can carry 1, 2 or 3, preferably 1 or 2, particularly preferably 1, substituent chosen from alkyl, aryl, COOR, COO⁻M⁺ and NE¹E², preferably alkyl. By way of example of such heterocycloaliphatic groups, mention may be made of pyrrolidinyl, piperidinyl, 2,2,6,6-tetramethyl-piperidinyl, imidazolidinyl, pyrazolidinyl, oxazolidinyl, morpholidinyl, thiazolidinyl, isothiazolidinyl, isoxazolidinyl, piperazinyl, tetrahydrothiophenyl, tetrahydrofuranyl, tetrahydropyranyl, dioxanyl.

Aryl comprises unsubstituted and substituted aryl groups and is preferably phenyl, tolyl, xylyl, mesityl, naphthyl, fluorenyl, anthracenyl, phenanthrenyl, naphthacenyl and in particular phenyl, tolyl, xylyl or mesityl.

Substituted aryl radicals have preferably 1, 2, 3, 4 or 5, in particular 1, 2 or 3, substituents chosen from alkyl, alkoxy, carboxyl, carboxylate, trifluoromethyl, —SO₃H, sulfonate, NE¹E², alkylene-NE¹E², nitro, cyano or halogen.

Hetaryl is preferably pyrrolyl, pyrazolyl, imidazolyl, indolyl, carbazolyl, pyridyl, quinolinyl, acridinyl, pyridazinyl, pyrimidinyl or pyrazinyl.

In the text below, compounds which can be derived from acrylic acid and methacrylic acid are sometimes referred to for short by adding the syllable “(meth)” to the compound derived from acrylic acid.

Particularly preferred polymers i) and b) are polymers which comprise (meth)acryl-amide and/or N-vinyllactams in copolymerized form.

Further preferred polymers i) and b) are polymers which comprise at least one monomer chosen from the group consisting of acrylamide, the N-vinyl derivatives of optionally alkyl-substituted 2-pyrrolidone, optionally alkyl-substituted 2-piperidone and optionally alkyl-substituted 6-caprolactam in copolymerized form.

Further preferred polymers i) and b) are polymers which comprise at least one monomer chosen from the group consisting of the N-vinyl derivatives of 2-pyrrolidone, 3-methyl-2-pyrrolidone, 4-methyl-2-pyrrolidone, 5-methyl-2-pyrrolidone, 3-ethyl-2-pyrrolidone, 3-propyl-2-pyrrolidone, 3-butyl-2-pyrrolidone, 3,3-dimethyl-2-pyrrolidone, 3,5-dimethyl-2-pyrrolidone, 5,5-dimethyl-2-pyrrolidone, 3,315-trimethyl-2-pyrrolidone, 5-methyl-5-ethyl-2-pyrrolidone, 3,4,5-trimethyl-2-pyrrolidone, 3-methyl-2-piperidone, 4-methyl-2-piperidone, 5-methyl-2-piperidone, 6-methyl-2-piperidone, 6-ethyl-2-piperidone, 3,5-dimethyl-2-piperidone, 4,4-dimethyl-2-piperidone, 3-methyl-ε-caprolactam, 4-methyl-ε-caprolactam, 5-methyl-α-caprolactam, 6-methyl-ε-caprolactam, 7-methyl-ε-caprolactam, 3-ethyl-ε-caprolactam, 3-propyl-e-caprolactam, 3-butyl-ε-caprolactam, 3,3-dimethyl-ε-caprolactam, 7,7-dimethyl-s-caprolactam and mixtures thereof in copolymerized form.

Further suitable polymers i) and b) are polymers which comprise, in copolymerized form, the amides of α,β-ethylenically unsaturated mono- and dicarboxylic acids with diamines which have one tertiary and one primary or secondary amino group. Suitable α,β-ethylenically unsaturated mono- and dicarboxylic acids of these amides are acrylic acid, methacrylic acid, fumaric acid, maleic acid, itaconic acid, crotonic acid, maleic anhydride, monobutyl maleate and mixtures thereof, preferably acrylic acid, methacrylic acid and mixtures thereof. Such amides suitable for incorporation into the polymers i) and b) by polymerization are, for example, N-[2-(dimethylamino)ethyl]acrylamide, N-[2-(dimethylamino)ethyl]methacrylamide, N-[3-(dimethylamino)propyl]acrylamide, N-[3-(dimethylamino)propyl]methacrylamide, N-[4-(dimethylamino)butyl]acrylamide, N-[4-(dimethylamino)butyl]methacrylamide, N-[2-(diethylamino)ethyl]acrylamide, N-[4-(dimethylamino)cyclohexyl]acrylamide, N-[4-(dimethylamino)cyclohexyl]methacrylamide etc. Preference is given to N-[3-(dimethylamino)propyl]acrylamide and N-[3-(dimethylamino)propyl]methacrylamide.

Polymer b) receives the amino groups by incorporating monomers carrying amino groups by polymerization Such monomers are, in principle, all monomers which are also suitable for the preparation of the polymers ii2), as described below.

Polymer i) comprises less than 0.49% by weight, preferably less than 0.3% by weight, particularly preferably less than 0.2% by weight and in particular less than 0.1 % by weight of acrolein or methacrolein based on the total weight of i) in copolymerized and/or grafted form. Very particularly prefered are polymers i) which comprise less than 0.05% by weight or neither acrolein nor methacrolein.

Polymers i) suitable for the use according to the invention have a K value of at least 17, preferably of at least 30, particularly preferably of at least 50 and at most of 170, preferably of at most 130 and particularly preferably of 110.

The polymers i) and b) are used according to the invention in an amount of from 0.05 to 10% by weight, preferably from 0.25 to 8% by weight, based on the total amount of the composition comprising water.

The polymers i) and b) can be prepared in all ways known to the person skilled in the art, for example by solution polymerization, precipitation polymerization, dispersion polymerization, emulsion polymerization, inverse emulsion polymerization or bulk polymerization.

Polymer ii)

Suitable as polymer ii) are, in principle, all polymers which are chosen from the group consisting of

(ii1) polymers which comprise branched polyethyleneimine structures,

(ii2) polymers comprising amino groups different from (ii1) and linear polyethyleneimines and

(ii3) mixtures of (ii1) and (ii2).

The amino groups may be primary, secondary, tertiary and/or quaternary amino groups.

Polymer ii1)

Polymers ii1) comprising branched polyethyleneimine structures (a diagrammatic section from a possible polymer chain is shown by formula II) are understood as meaning branched polyethyleneimines and all polymers which are grafted with ethyleneimine. Branched polyethyleneimine structures means that the polyethyleneimine structures have at least one branching point in the polymer structure. Preferably, besides secondary amino groups as occur in linear, unbranched polyethyleneimines, the polymers ii1) also comprise both primary and tertiary amino groups. As a result of protonation and/or quaternization it is of course also possible for ammonium groups to be present.

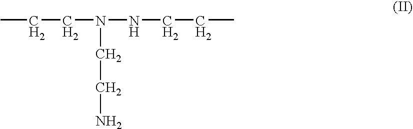

The polymers ii1) comprising branched polyethyleneimine structures can be of high molecular weight, crosslinked and/or carry carboxylate groups.

Branched polyethyleneimines are prepared, for example, by polymerization of ethyleneimine in aqueous solution in the presence of acid-cleaving compounds, acids or Lewis acids as catalyst. Branched polyethyleneimines have, for example, molar masses M_{w} up to 2.5 million, preferably from 800 to 2 100 000. Particular preference is given to using branched polyethyleneimines with molar masses of from 800 to 1 750 000. Linear and branched polyethyleneimines can, if appropriate, be modified, e.g. alkoxylated, alkylated or amidated. Moreover, they can be subjected to a Michael addition or a Stecker synthesis. The derivatives of polyethyleneimines obtainable in the process are likewise suitable as polymers ii1).

Further suitable as polymers ii1) are polyamidoamines grafted with ethyleneimine which are obtainable, for example, by condensation of dicarboxylic acids with polyamines and subsequent grafting on of ethyleneimine. Suitable polyamidoamines are obtained, for example, by reacting dicarboxylic acids having 4 to 10 carbon atoms with polyalkylenepolyamines which comprise 3 to 10 basic nitrogen atoms in the molecule. Examples of dicarboxylic acids are succinic acid, maleic acid, adipic acid, glutaric acid, suberic acid, sebacic acid or terephthalic acid. In the preparation of the polyamidoamines it is also possible to use mixtures of dicarboxylic acids, likewise mixtures of two or more polyalkylenepolyamines. Suitable polyalkylenepolyamines are, for example, diethylenetriamine, triethylenetetramine, tetraethylenepentamine, dipropylenetriamine, tripropylenetetramine, dihexamethylenetriamine, aminopropylethylenediamine and bisaminopropylethylenediamine. To produce the polyamidoamines, the dicarboxylic acid and polyalkylenepolyamines are heated to elevated temperatures, e.g. to temperatures in the range from 120 to 220° C., preferably 130 to 180° C. The water which forms during the condensation is removed from the system. During the condensation, it is also possible, if appropriate, to use lactones or lactams of carboxylic acids having 4 to 8 carbon atoms. Per mole of a dicarboxylic acid, 0.8 to 1.4 mol of a polyalkylenepolyamine, for example, is used. These polyamidoamines are grafted with ethyleneimine. The grafting reaction is carried out, for example, in the presence of acids or Lewis acids, such as sulfuric acid or boron trifluoride etherates at temperatures of from, for example, 80 to 100° C. Compounds of this type are described, for example, in DE-B-24 34 816. The optionally crosslinked polyamidoamines, which, if appropriate, are also additionally grafted prior to crosslinking with ethyleneimine, can also be used according to the invention as polymers ii1). The crosslinked polyamidoamines grafted with ethyleneimine are water-soluble and have, for example, an average molecular weight M_{w} of from 3000 to 2 million daltons. Customary crosslinkers are, for example, epichlorohydrin or bischlorohydrin ether of alkylene glycols and polyalkylene glycols.

Suitable polymers ii1) are, for example, the Lupasol® grades, such as Lupasol® 100, Lupasol® FG, Lupasol® 20 anhydrous, Lupasol® 20, Lupasol® 35, Lupasol® 500, Lupasol®HEO 1, Lupasol®HF, Lupasol®P, Lupasol®PN 50, Lupasol®PO 100, Lupasol®PR 8515, Lupasol®PS, Lupasol®SK, Lupasol®WF (in each case BASF), Epomin®SP-003, Epomin®SP-006, Epomin®SP-006D₇ Epomin®SP-012, Epomin®SP-018, Epomin®SP-018D, Epomin®SP-103, Epomin®SP-110, Epomin®SP-200, Epomin®P-1000, Epomin®P-1010, Epomin®P-1050 (in each case Nippon Shokubai).

Of particular suitability are high molecular weight polyethyleneimines with molecular weights M_{w} in the range from 100 000 to 3 million, such as, for example, Lupasol®P (M_{w} about 750 000) or Lupasol®SK (M_{w} about 2 million).

If polymer ii1) is used, then polymer i) and polymer ii1) are used in a weight ratio of at most 30 1, preferably at most 20:1, particularly preferably at most 10:1 and in particular 5:1 and at least 1:30, preferably at least 1 :20, more preferably at least 1:10, particularly preferably at least 1:5 and in particular at least 1:3 for modifying the rheology of compositions comprising water.

If polymer i) is a copolymer comprising (meth)acrylamide, then a weight ratio of polymer i) to polymer ii1) in the range from 1:1 to 1:20 is particularly preferred.

If polymer i) is a copolymer comprising N-vinyllactam, then a weight ratio of polymer i) to polymer ii1) in the range from 10:1 to 1:5 is particularly preferred.

Polymer ii2)

Polymers ii2) are different from ii1) and linear polyethyleneimines. A preferred embodiment of the invention is the use according to the invention where the polymers ii2) comprising amino groups comprise structural units of the general formula III

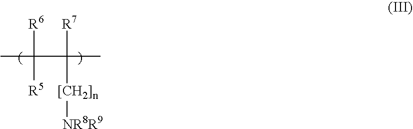

where

R⁵ to R⁹, independently of one another, are hydrogen, C₁-C₂₀—, in particular C₁-C₆-alkyl, -aryl or -alkylaryl, or R⁸ and R⁹, together with the nitrogen atom to which they are bonded, can form a 5 to 8-membered N-heterocycle and n is 0, 1,2,3 or 4.

Preference is given to polymers ii2) which comprise structural units of the general formula III where R⁵ to R⁹ are hydrogen and n is 0 or 1, i.e. polymers ii2) which comprise structural units derived from vinylamine or allylamine.

The structural units according to formula III can be produced by incorporating a suitable monomer by polymerization or by polymer-analogous reaction of a polymer.

Polymers comprising vinylamine units are known, cf. U.S. Pat. No. 4,421,602, U.S. Pat. No. 5,334,287, EP-A-0 216 387, U.S. Pat. No. 5,981,689, WO-A-00/63295 and U.S. Pat. No. 6,121,409. They are prepared by at least partial hydrolysis of open-chain polymers comprising N-vinylcarboxamide units.

N-Vinylcarboxamide monomers have a structure according to the general formula IV:

CR⁵R⁶═CR⁷NR⁸C(O)R¹¹ (IV)

where R⁵ to R⁸ are as defined for formula III and R¹ is likewise hydrogen, C₁-C₂₀-alkyl, -aryl or -alkylaryl.

The N-vinylcarboxamide polymers are obtainable, for example, by polymerization of N-vinylformamide, N-vinyl-N-methylformamide, N-vinylacetamide, N-vinyl-N-methylacetamide, N-vinyl-N-ethylacetamide and N-vinylpropionamide. The specified monomers can be polymerized either on their own or be copolymerized with other monomers.

Suitable monoethylenically unsaturated monomers which are copolymerized with the N-vinylcarboxamides are all of the compounds copolymerizable therewith.

Such suitable monomers are chosen, for example, from the group consisting of acrylic acid, methacrylic acid, ethacrylic acid, alpha-chloroacrylic acid, crotonic acid, maleic acid, maleic anhydride, itaconic acid, citraconic acid, mesaconic acid, glutaconic acid, aconitic acid and fumaric acid. Also suitable are the half-esters of monoethylenically unsaturated dicarboxylic acids having 4 to 10, preferably 4 to 6, carbon atoms, e.g. of maleic acid, such as monomethyl maleate. Also suitable are, in addition, the salts of the abovementioned acids, in particular the sodium, potassium and ammonium salts. The monomers can be used as they are or as mixtures with one another.

Other examples of suitable monomers are vinyl esters of saturated carboxylic acids of 1 to 6 carbon atoms, such as vinyl formate, vinyl acetate, vinyl propionate and vinyl butyrate, and vinyl ethers, such as C₁- to C₆-alkyl vinyl ethers, e.g. methyl or ethyl vinyl ether. Further suitable comonomers are esters, amides and nitrites of ethylenically unsaturated C₃- to C₆-carboxylic acids, for example methyl acrylate, methyl methacrylate, ethyl acrylate and ethyl methacrylate, acrylamide and methacrylamide and acrylonitrile and methacrylonitrile.

Further examples of suitable monomers are carboxylic esters derived from glycols or polyalkylene glycols, where in each case only one OH group is esterified, e.g. hydroxyethyl acrylate, hydroxyethyl methacrylate, hydroxypropyl acrylate, hydroxybutyl acrylate, hydroxypropyl methacrylate, hydroxybutyl methacrylate, and acrylic monoesters of polyalkylene glycols with a molar mass of from 500 to 10 000. Further suitable comonomers are esters of ethylenically unsaturated carboxylic acids with aminoalcohols, such as, for example, dimethylaminoethyl acrylate, dimethylaminoethyl methacrylate, diethylaminoethyl acrylate, diethylaminoethyl methacrylate, dimethylaminopropyl acrylate, dimethylaminopropyl methacrylate, diethylaminopropyl acrylate, dimethylaminobutyl acrylate, diethylaminobutyl acrylate or N-tert-butylaminoethyl methacrylate. The basic acrylates can be used in the form of the free bases, the salts with mineral acids, such as hydrochloric acid, sulfuric acid or nitric acid, the salts with organic acids, such as formic acid, acetic acid, propionic acid or the sulfonic acids in quaternized form. Suitable quaternizing agents are, for example, dimethyl sulfate, diethyl sulfate, methyl chloride, ethyl chloride or benzyl chloride.

Further suitable comonomers are amides of ethylenically unsaturated carboxylic acids, such as acrylamide, methacrylamide, and N-alkylmono- and diamides of monoethylenically unsaturated carboxylic acids with alkyl radicals from 1 to 6 carbon atoms, e.g. N-methylacrylamide, N,N-dimethylacrylamide, N-methylmethacrylamide, N-ethylacrylamide, N-propylacrylamide and tert-butylacrylamide, and basic (meth)acrylamides, such as, for example, dimethylaminoethylacrylamide, dimethylaminoethylmethacrylamide, diethylaminoethylacrylamide, diethylaminoethylmethacrylamide, dimethylaminopropylacrylamide, diethylaminopropyl-acrylamide, dimethylaminopropylmethacrylamide and diethylaminopropylmethacrylamide.

Also suitable as comonomers are N-vinylpyrrolidone, N-vinylcaprolactam, acrylonitrile, methacrylonitrile, N-vinylimidazole and substituted N-vinylimidazoles, such as, for example, N-vinyl-2-methylimidazole, N-vinyl-4-methylimidazole, N-vinyl-5-methylimidazole, N-vinyl-2-ethylimidazole and N-vinylimidazolines, such as N-vinylimidazoline, N-vinyl-2-methylimidazoline and N-vinyl-2-ethylimidazoline. N-Vinylimidazoles and N-vinylimidazolines are used not only in the form of the free bases but also in a form neutralized with mineral acids or organic acids or in quaternized form, the quaternization preferably being carried out with dimethyl sulfate, diethyl sulfate, methyl chloride or benzyl chloride. Also suitable are diallyidialkylammonium halides, such as, for example, diallyidimethylammonium chloride.

Also suitable as comonomers are monoethylenically unsaturated monomers comprising sulfonic acid or phosphonic acid groups, such as, for example, 2-acrylamido-2-methylpropanesulfonic acid (AMPS®, Lubrizol), vinyisulfonic acid or vinylphosphonic acid.

Preferred polymers ii2) are the at least partially hydrolyzed homopolymers of the abovementioned N-vinylcarboxamide monomers.

Suitable precursors for the polymers ii2) likewise suitable for the use according to the invention are, for example, copolymers which comprise
95 to 5 mol %, preferably 90 to 10 mol %, of at least one N-vinylcarboxamide and
5 to 95 mol %, preferably 10 to 90 mol %, of other monoethylenically unsaturated monomers copolymerizable therewith

in copolymerized form. The monomers preferably comprise no acid groups.

In order to prepare polymers comprising N-vinylamine units, it is preferable to start from homopolymers of N-vinylformamide or from copolymers which are obtainable by copolymerization of
N-vinylformamide with
vinyl formate, vinyl acetate, vinyl propionate, acrylonitrile, N-vinylcaprolactam, N-vinylurea, N-vinylpyrrolidone or C₁- to C₆-alkyl vinyl ethers.

Subsequent at least partial hydrolysis of the homopolymers or of the copolymers with formation of vinylamine units from the copolymerized N-vinylformamide units gives the polymers comprising N-vinylamine units.

The hydrolysis of the polymers described above is carried out by known methods through the action of acids, bases, metallic catalysts or enzymes. When using acids as hydrolyzing agents, the vinylamine units of the polymers are present as ammonium salt, whereas in the hydrolysis with bases (e.g. with metal hydroxides, in particular with alkali metal and alkaline earth metal hydroxides) the free amino groups arise. In particular cases, the hydrolysis can also be carried out with the help of ammonia or amine.

If acids are used as hydrolyzing agent, then these are preferably mineral acids, such as hydrogen halides, which can be used in gaseous form or as an aqueous solution. Preferably used acids are concentrated hydrochloric acid, sulfuric acid, nitric acid or phosphoric acid, and organic acids, such as C1- to C5 carboxylic acids, and aliphatic or aromatic sulfonic acids. For example, per formyl group equivalent in the polymers comprising N-vinylformamide units in copolymerized form, 0.05 to 2, in particular 1 to 1.5, mole equivalents of an acid are required. The hydrolysis of the polymers comprising N-vinylformamide units proceeds significantly more quickly than that of the polymers having N-vinylacetamide units. If copolymers of the N-vinylcarboxamides under consideration with other comonomers are subjected to hydrolysis, the comonomer units present in the copolymer can also be chemically changed. Thus, for example, vinyl acetate units give vinyl alcohol units, methyl acrylate units give acrylic acid units and acrylonitrile units give acrylamide or acrylic acid units.

On an industrial scale, it is advantageous to neutralize polymers prepared by solution polymerization with sodium hydroxide solution, and polymers prepared by water-in-water emulsion polymerization by acid, in particular sulfuric acid.

The degree of hydrolysis of the homopolymers determines the content of vinylamine units in the polymers.

It is known that the homopolymers and copolymers comprising vinylamine units can also comprise amide units which are formed as a result of the reaction of formic acid with two adjacent amino groups or by intramolecular reaction of amino groups with adjacent amide groups.

The polymers comprising vinylamine units can be used in salt-containing or in salt-free form.

Polymers comprising vinylamine units also include at least partially hydrolyzed graft polymers of, for example, N-vinylformamide on polyalkylene glycols, polyvinyl acetate, polyvinyl alcohol, polyvinylformamides, polysaccharides, such as starch, oligosaccharides or monosaccharides. The graft polymers are obtainable by, for example, free-radically polymerizing N-vinylformamide in an aqueous medium in the presence of at least one of the specified graft bases, if appropriate together with further copolymerizable monomers, and hydrolyzing the grafted-on vinylformamide unit to give vinylamine units in the manner described above.

The polymers comprising vinylamine units can, if appropriate, also be crosslinked. Crosslinked polymers can be obtained by two different methods. For example, it is possible to carry out the polymerization of N-vinylcarboxamides in the presence of a crosslinker. Suitable crosslinkers here are monomers which comprise at least two ethylenically unsaturated double bonds, e.g. butanediol diacrylate, butanediol dimethacrylate, N,N′-methylenebisacrylamide, divinylurea, divinyidioxane, diacrylates or dimethacrylates of polyethylene glycols of a molar mass of, for example, 100 to 10 000, preferably 200 to 500, pentaerythritol triallyl ether, trimethylolpropane triacrylate and triacrylates or trimethacrylates of alkoxylated trimethylolpropane which has been alkoxylated with 3 to 90, preferably with 6 to 60, mol of ethylene oxide and/or propylene oxide. Polymers comprising vinylamine units can, however, also be crosslinked by reacting them with at least bifunctional compounds such as diepoxides, epihalohydrines, dihaloalkanes and/or dicarboxylic acids. Examples of such crosslinkers are bischlorohydrine ether or bisepoxides of polyethylene glycols with molar masses of from 100 to 500, glutardialdehyde, succinic acid or 1,2-dichloroethane.

The polymers ii2) suitable for the use according to the invention are preferably at least partially hydrolyzed homopolymers and copolymers of N-vinylcarboxamide monomers, such as homopolymers and copolymers of N-vinylformamide, N-vinylacetamide or N-methyl-N-vinylacetamide, in particular homopolymers of N-vinylformamide and/or copolymers of N-vinylformamide with a monomer chosen from the group consisting of acrylic acid, vinyl acetate, vinyl alcohol, vinylpyrrolidone, acrylamide and mixtures thereof.

The total amount of N-vinylcarboxamide units, in particular of N-vinylformamide units and/or N-vinylacetamide units, in the polymers is I to 100%, preferably at least 50, particularly preferably at least 70, very particularly preferably at least 80 and especially at least 90%, hydrolyzed.

Polymers ii2) particularly suitable for the use according to the invention have a molecular weight M_{w} in the range from 80 000 to 3 million. Preferred polymers ii2) are, as already described, obtainable by at least partial hydrolysis from poly-N-vinylcarboxamides, such as, for example, poly-N-vinylformamide or poly-N-vinylacetamide, where the poly-N-vinylcarboxamides have K values in the range from 40 to 200, preferably from 60 to 170, particularly preferably from 80 to 120. According to the invention, the number of amino groups and the K value of polymer ii2) are chosen such that the mixture of polymer i) and polymer ii2) achieves the desired rheology-modifying effect.

Suitable polymers ii2) are polyvinylamines, such as, for example, those with the trade name Luresin® (BASF), Luresin®PR 8086 with a K value of about 90 and a hydrolysis of about 95% is particularly suitable.

The polymers ii2) can be prepared by all ways known to the person skilled in the art, for example by solution polymerization, precipitation polymerization, dispersion polymerization, emulsion polymerization, inverse emulsion polymerization or bulk polymerization.

Also suitable as polymer ii2) are naturally occurring polymers comprising amino groups, such as, for example, chitosan and chitosan derivatives.

In addition, the polymer ii2) comprising amino groups can also be obtained by at least partial hydrogenation of homopolymers and copolymers of acrylonitrile.

If polymer ii2) is used as polymer ii), then the weight ratio of the sum of the monomer building blocks of polymer i) carrying amide groups to the sum of the monomer building blocks of polymer ii2) carrying amino groups is in the range from less than 27-1 to 1:30, preferably in the range from 25:1 to 1:25, further preferably from 20.1 to 1:20, especially preferably from 15:1 to 1 15.

Further preference is given to weight ratios of from 3:1 to 1:3, in particular 2.3:1 to 1.7:1 or 1:1.7 to 1:2.3. Weight ratios of about 1:1 are also advantageous.

According to the invention, the polymers ii2) are used in an amount of from 0.05 to 10% by weight, preferably from 0.25 to 7% by weight, based on the total amount of the composition comprising water.

It is advantageous to prepare one of the polymers i) or ii) in presence of the other, for example by water-in-water emulsion polymerization.

Polymer b)

The polymer b) comprising at least one amide and amino groups in which the quantitative ratio of amide groups to amino groups is in the range from 20:1 to 1:20 simultaneously comprises structural units like polymer i) and polymer ii). Polymer b) can accordingly be prepared by copolymerization of monomers carrying amide groups suitable for preparing polymer i), as described above, with monomers carrying amino groups or groups which can be hydrolyzed/hydrogenated to amino groups and are suitable for preparing polymer ii), as described above.

Molecular Weight, K Value and Degree of Hydrolysis

In a further preferred embodiment of the invention, according to the invention, use is made of mixtures of the polymers i) and ii1) of the type such as the K value of polymer i) is in the range greater than 17 to 170 and the molecular weight M_{w} of polymer ii1) is in the range from 100 000 to 3 million and is preferably at least 300 000 g/mol, particularly preferably at least 500 000 and in particular at least 700 000 g/mol.

In a further preferred embodiment of the invention, use is made according to the invention of polymers i) and ii2) of the type such that the K value of i) is in the range greater than 17 to 170 and the molecular weight M_{w} of ii2) is in the range from 80 000 to 3 million g/mol.

Also preferred is the use of polymer i) and of a polymer ii2), which is obtainable by 80 to 100% hydrolysis of the N-vinylcarboxamide units of a poly-N-vinylcarboxamide with a K value between 45 and 90.

Also preferred is the use of polymer i) and of a polymer ii2) which is obtainable by 20 to 80% hydrolysis of the vinylcarboxamide units of a polyvinylcarboxamide with a K value in the range from 90 to 200.

Further Uses

Also preferred is the use according to the invention for the thickening of cosmetic, dermatological or pharmaceutical preparations comprising water.

Preference is also given to the use according to the invention for the thickening of liquid detergents.

In a preferred embodiment of the invention, the rheology of the compositions comprising water is changed in such a way, i.e. the viscosity is increased in such a way, that cut-resistant gels form. For this, depending on the K value, molecular weight and number and type of amide and amino groups of polymer i) and ii) or b), the concentrations and the pH of the composition are adjusted until the desired viscosity is reached.

“Cut-resistant” is used to refer to gels which have a high mechanical stability, are largely dimensionally stable and only change their geometric shape slowly, comparable with the cold flow of polymers. Polymers which have cold flow are, for example, polyisobutenes obtainable under the trade names Oppanol®200 or Oppanol® B 150.

High-viscosity aqueous compositions prepared in this way can be used as carrier material for active ingredients where, for example, a spontaneous active ingredient release is not desired, but a delayed active ingredient release over a prolonged time (slow-release effect), or a gel-like administration form is advantageous due to handleability being improved.

Such active ingredients may in principle be all organic and inorganic materials. By way of example, mention may be made of surfactants, color transfer inhibitors, complexing agents, perfumes, biocides, agrochemical active ingredients, pharmaceutical active ingredients, pigments, dyes, enzymes, minerals, vitamins and disintegrates.

For example, the cut-resistant gels can be used in detergents and cleaners. The cut-resistant gel can be used as carrier material for washing-active components or itself as active component in detergents and cleaners. The effect of polyvinylpyrrolidone (polymer i)) as color transfer inhibitor in detergents is known (e.g. Sokalan® grades).

The cut-resistant gel which comprises the active ingredients is comminuted and introduced, for example in the form of gel particles, into a liquid formulation in order to be able to make the active ingredients visible in a formulation. When using such a gel formulation, the gel particles are dissolved as a result of dilution with water, in particular at elevated temperature, and the active ingredient is gradually released.

When using the gels as carrier matrix, active ingredients can be applied and/or added in a targeted manner. In this connection, if desired, the gradual dissolution of the matrix can lead to a targeted release of the active ingredients. As a result of migration of the active ingredient within this matrix, a targeted release of the active ingredient via the interface of the matrix is achieved.

Examples of active ingredients/active substances which can be formulated in this way are agrochemical active ingredients, such as herbicides, fungicides, insecticides, acaricides, cleaners for hard and soft surfaces or active ingredients for surface treatment,

In a further preferred embodiment of the invention, the gels obtained which, if appropriate, comprise active ingredients can be dried and be used as powders or tablets for producing detergents and cleaners.

The aqueous gels which form as a result of appropriately increasing the viscosity of the composition comprising water can form a protective and/or decorative surface layer (coating) on, for example, tablets or other pharmaceutical or cosmetic administration forms.

A further advantageous use is therefore the use of the polymer combinations of polymer i) and ii) or b) for producing a protective layer on a surface. Upon soiling of the surface, the soil can be rinsed off again with water on account of the layer located between surface and soil which comprises the polymers i) and ii) or b).

Depending on its solubility, the polymer complex of i) and ii) or b) is rinsed off again from the surface correspondingly quickly or slowly. If the abovementioned parameters are suitably chosen, the residence time of the polymer layer on the surface can be variably configured. Examples of such a use is the use in sanitary installations for avoiding or preventing the adhesion of undesired deposits such as, for example, the deposition of lime or feces.

A further advantageous use is the use of the polymer combinations of polymer i) and ii) or b) in compositions comprising water for producing coatings for surface hydrophobization. By applying the mixtures of the polymers i) and ii) or polymer b), if appropriate in combination with components which protect against corrosion (corrosion inhibitors), it is possible to produce protection for coated or uncoated surfaces, for example metal surfaces.

It is also advantageous to use the polymers i) and ii) or b) in compositions comprising water for producing gel components which are to be used, for example, in wound coverings. The gel advantageously comprises pharmaceutical active ingredients.

A further advantageous use is the use of the polymer mixtures of polymer i) and ii) or b) in compositions comprising water for producing carrier materials for cosmetic or dermatological active ingredients.

A further advantageous use is the use of the polymer mixtures of polymer i) and ii) or b) in compositions comprising water for producing gels which can be used, through incorporating perfume, for example for producing air fresheners.

A further advantageous use is the use of the polymer mixtures of polymer i) and ii) or b) in compositions comprising water for producing gels with odor-absorbing properties (if appropriate with the addition of further odor-absorbing components into the gel matrix) which can be used for improving the quality of room air.

A further advantageous use is the use of the polymer combinations of polymer i) and ii) or b) in compositions comprising water for producing gels which can be used for absorbing harmful substances.

It is also advantageous to produce thickened compositions comprising water through spray-drying and/or granulation or by corresponding adjustment of the parameters concentration, molecular weight M_{w}, weight ratio or quantitative ratio of amide to amino groups of the polymers i) and ii) or b) and pH value, from the low-viscosity compositions comprising water, which are in the form of a solution, emulsion, suspension or dispersion and, if appropriate, also comprise active ingredients. The abovementioned thickened compositions can also be largely freed from solvents, dried and ground. In addition, it is possible to cool the compositions and, upon achieving an adequate rigidity, to grind them.

A further advantageous use is the use of the polymer combinations of polymer i) and ii) or b) in compositions comprising water for producing detergents and cleaners.

A further advantageous use is the use of the polymer combinations of polymer i) and ii) or b) in compositions comprising water for producing wound coverings.

A further advantageous use is the use of the polymer combinations of polymer i) and ii) or b) in compositions comprising water in enhanced oil recovery processes.

A further advantageous use is the use of the polymer combinations of polymer i) and ii) or b) in compositions comprising water for the treatment of surfaces.

A further advantageous use is the use of the polymer combinations of polymer i) and ii) or b) in compositions comprising water for producing crop protection compositions.

Method

The invention further provides a method of modifying the rheology of compositions comprising water, comprising at least one of the steps
a) adding the polymers i) and ii) to the composition comprising water where, if polymer ii2) is used, the weight ratio of i) to ii2) is in the range from less than 27:1 to 1:30 and where the polymers i) and ii) are present separately prior to the addition and where the addition takes place simultaneously or not simultaneously;
b) adding a mixture of the polymers i) and ii) to the composition comprising water where, if polymer ii2) is used, the weight ratio i) to ii2) is in the range from less than 27:1 to 1:30,
c) adding a polymer b) to the composition comprising water.

Preference is given to a method such as this wherein also the pH of the composition comprising water after the at least one step a), b) or c) is adjusted to a value greater than 3, preferably greater than 5, particularly preferably greater than 6 and in particular greater than 7 and less than 1 1, preferably less than 10 and particularly preferably less than 9, if polymer ii2) is used as polymer ii).

If a polymer ii1) is used as polymer ii), then the desired thickening effect is achieved over a broad pH range. The thickening effect is virtually independent of the pH of the preparation comprising water.

It is also advantageous to carry out the method according to the invention at a temperature greater than 1 5° C., preferably greater than 20° C. and less than 95° C., preferably less than 80° C.

If a polymer ii1) is used as polymer ii), then it is advantageous to carry out the method according to the invention at a temperature of at most 50° C.

In a preferred embodiment of the method, the total weight of the in the at least one step a) to c) of all polymers i), ii) and/or b) added to the composition comprising water is 0.1 to 20% by weight, preferably 0.5 to 15% by weight and in particular 0.5 to 10% by weight, based on the total weight of the composition comprising water.

In a further preferred embodiment of the method, a composition comprising water and 0.05 to 10% by weight of polymer i) is combined with a 0.05 to 10% by weight aqueous solution of polymer ii2), with the proviso that the weight ratio of polymer i) to polymer ii2) is in the range from 20:1 to 1:10, preferably from 10:1 to 1:5.

In a further preferred embodiment of the method, separate aqueous solutions of the polymers i) and ii) are sprayed onto surfaces through mixing nozzles. The viscosity of the individual aqueous solutions is chosen depending on the nozzle and valve such that the solutions are still sprayable. The spraying through the mixing nozzle ensures a bringing into contact of the solutions and for increasing the viscosity of the aqueous composition. Depending on the concentration of the polymer solutions, temperature, properties of the mixing nozzle and the time before striking the surface, a gel can form as early as during the spraying operation or once on the surface.

In a further preferred embodiment of the method, a combined solution of all components is sprayed, which is of low viscosity in the dilute state. This is achieved through appropriate choice of the parameters concentration, molecular weight M_{w}, weight ratio or quantitative ratio of amide to amino groups of the polymers i) and ii) or b) and pH.

By spraying on the combined solution and subsequently evaporating the solvent it is possible to apply high-viscosity to gel-like mixtures to surfaces. This method is advantageous if a high viscosity coating is to be applied, for example, evenly and with a homogeneous layer thickness and/or to a place of a substrate which is difficult to access.

Accordingly, the invention further provides composition comprising water, in particular gels, which are obtainable by the abovementioned methods according to the invention

The invention further provides mixtures comprising
i) at least one polymer containing amide groups having a K value in the range from greater than 17 to 170 and
ii) at least one further polymer chosen from the group consisting of
   (ii1) polymers which comprise branched polyethyleneimine structures,
   (ii2) polymers containing amino groups different from (ii1) and linear polyethyleneimines,
      where the weight ratio of polymer i) to polymer ii1) is in the range from 30:1 to 1:30 and
      where the weight ratio of the sum of the monomer building blocks of polymer i) carrying the amide groups to the sum of the monomer building blocks of polymer ii2) carrying the amino groups is in the range from less than 27:1 to 1:30,
      with the proviso that i) comprises less than 0.49% by weight of acrolein, based on the total weight of i) in copolymerized and/or grafted form and
      with the proviso that the degree of hydrolysis is greater than 75%, preferably at least 80% if polymer ii2) is obtained by hydrolysis of polyvinylformamide.

In a preferred embodiment, the specified mixtures consist of
i) at least one poly-N-vinyllactam with a K value in the range from at least 30 to 170 and
ii) at least one polymer comprising vinylamine units.

In a further preferred embodiment, the specified mixtures consist of
i) at least one poly-N-vinyllactam with a K value in the range from at least 30 to 170 and
ii) at least one polymer comprising branched polyethyleneimine units.

The invention further provides the use of the abovementioned mixtures for producing detergents and cleaners, wound coverings or crop protection compositions or in enhanced oil recovery processes.

Cosmetic, Dermatological and Pharmaceutical Compositions

The mixtures according to the invention are used, for example, for modifying the rheology of cosmetic, dermatological or pharmaceutical compositions comprising water which, apart from the mixture according to the invention, have a cosmetically, dermatologically or pharmaceutically acceptable carrier B) which is chosen from

i) water,

ii) water-miscible organic solvents, preferably C₂-C₄-alkanols, in particular ethanol,

iii) oils, fats, waxes,

iv) esters of C₆-C₃₀-monocarboxylic acids with mono-, di- or polyhydric alcohols different from iii),

v) saturated acyclic and cyclic hydrocarbons,

vi) fatty acids,

vii) fatty alcohols,

viii) propellant gases and mixtures thereof.

The compositions have, for example, an oil or fat component B) which is chosen from: hydrocarbons of low polarity, such as mineral oils; linear saturated hydrocarbons, preferably having more than 8 carbon atoms, such as tetradecane, hexadecane, octadecane etc.; cyclic hydrocarbons, such as decahydronaphthalene; branched hydrocarbons; animal and vegetable oils; waxes; wax esters; Vaseline; esters, preferably esters of fatty acids, such as, for example, the esters of C₁-C₂₄-monoalcohols with C₁-C₂₂-monocarboxylic acids, such as isopropyl isostearate, n-propyl myristate, isopropyl myristate, n-propyl palmitate, isopropyl palmitate, hexacosanyl paimitate, octacosanyl palmitate, triacontanyl palmitate, dotriacontanyl palmitate, tetratriacontanyl palmitate, hexancosanyl stearate, octacosanyl stearate, triacontanyl stearate, dotriacontanyl stearate, tetratriacontanyl stearate; salicylates, such as C₁-C₁₀-salicylates, e.g. octyl salicylate; benzoate esters, such as C₁₀-C₁₅-alkyl benzoates, benzyl benzoate; other cosmetic esters, such as fatty acid triglycerides, propylene glycol monolaurate, polyethylene glycol monolaurate, C₁₀-C₁₅-alkyl lactates, etc. and mixtures thereof.

Suitable silicone oils B) are, for example, linear polydimethylsiloxanes, poly(methyl-phenylsiloxanes), cyclic siloxanes and mixtures thereof. The number-average molecular weight of the polydimethylsiloxanes and poly(methylphenylsiloxanes) is preferably in a range from about 1000 to 150 000 g/mol. Preferred cyclic siloxanes have 4- to 8-membered rings. Suitable cyclic siloxanes are commercially available, for example, under the name cyclomethicone.

Preferred oil and fat components B) are chosen from paraffin and paraffin oils; Vaseline; natural fats and oils, such as castor oil, soya oil, peanut oil, olive oil, sunflower oil, sesame oil, avocado oil, coco butter, almond oil, peach kernel oil, resinous oil, cod-liver oil, lard, spermaceti, spermaceti oil, sperm oil, wheat germ oil, macadamia nut oil, evening primrose oil, jojoba oil; fatty alcohols, such as lauryl alcohol, myristyl alcohol, cetyl alcohol, stearyl alcohol, oleyl alcohol, cetyl alcohol; fatty acids, such as myristic acid, stearic acid, palmitic acid, oleic acid, linoleic acid, linolenic acid and saturated, unsaturated, and substituted fatty acids different therefrom; waxes, such as beeswax, carnauba wax, candililla wax, spermaceti and mixtures of the abovementioned oil and fat components.

Suitable cosmetically and pharmaceutically compatible oil and fat components B) are described in Karl-Heinz Schrader, Grundlagen und Rezepturen der Kosmetika [Fundamentals and formulations of cosmetics], 2nd Edition, Verlag Hüthig, Heidelberg, pp. 319-355, which is hereby incorporated by reference.

Suitable hydrophilic carriers B) are chosen from water, 1-, 2- or polyhydric alcohols having preferably 1 to 8 carbon atoms, such as ethanol, n-propanol, isopropanol, propylene glycol, gycerol, sorbitol, etc.

The cosmetic compositions may be skin cosmetic or hair cosmetic compositions.

Preferably, the compositions are in the form of a spray, gel, foam, ointment, cream, emulsion, suspension, lotion, milk or paste. If desired, liposomes or microspheres can also be used.

The cosmetic, dermatological or pharmaceutical compositions can additionally comprise cosmetically, dermatologically or pharmaceutically active ingredients, and auxiliaries.

Preferably, the compositions comprise at least one mixture a), as defined above, comprising polymers i) and ii) or polymer b) (=component A), at least one carrier B) as defined above and at least one constituent different therefrom which is chosen from cosmetically active ingredients, emulsifiers, surfactants, preservatives, perfume oils, further thickeners, hair polymers, hair and skin conditioners, graft polymers, water-soluble or dispersible silicone-containing polymers, photoprotective agents, bleaches, gel formers, care agents, colorants, tinting agents, tanning agents, dyes, pigments, consistency regulators, humectants, refatting agents, collagen, protein hydrolysates, lipids, antioxidants, antifoams, antistats, emollients and softeners.

Thickeners

The cosmetic, dermatological or pharmaceutical compositions can, in addition to the rheology-modifying mixture a) or the rheology-modifying polymer b), also comprise further thickeners. However, it is preferred to use no further thickeners.

Typical thickeners in such formulations are crosslinked polyacrylic acids and derivatives thereof, polysaccharides and derivatives thereof, such as xanthan gum, agar agar, alginates or tyloses, cellulose derivatives, e.g. carboxymethylcellulose or hydroxycarboxymethylcellulose, fatty alcohols, monoglycerides and fatty acids, polyvinyl alcohol and polyvinylpyrrolidones. Preference is given to using nonionic thickeners.

Cosmetically and/or Dermatologically Active Ingredients

Suitable cosmetically and/or dermatologically active ingredients are, for example, coloring active ingredients, skin and hair pigmentation agents, tinting agents, tanning agents, bleaches, keratin-hardening substances, antimicrobial active ingredients, photofilter active ingredients, repellent active ingredients, hyperemic substances, keratolytic and keratoplastic substances, antidandruff active ingredients, antiphlogistics, keratinizing substances, active ingredients which are antioxidative or act as free-radical scavengers, substances which moisturize the skin or retain moisture in the skin, refatting active ingredients, antierythimatos or antiallergic active ingredients and mixtures thereof.

Active ingredients which tan the skin artificially which are suitable for tanning the skin without natural or artificial irradiation with UV rays are, for example, dihydroxyacetone, alloxan and walnut shell extract. Suitable keratin-hardening substances are generally active ingredients as are also used in antiperspirants, such as, for example, potassium aluminum sulfate, aluminum hydroxychloride, aluminum lactate, etc. Antimicrobial active ingredients are used in order to destroy microorganisms and/or to inhibit their growth and thus serve both as preservatives and also as a deodorizing substance which reduces the formation or the intensity of body odor. These include, for example, customary preservatives known to the person skilled in the art, such as p-hydroxybenzoic esters, imidazolidinylurea, formaldehyde, sorbic acid, benzoic acid, salicylic acid etc. Such deodorizing substances are, for example, zinc ricinoleate, triclosan, undecylenic acid alkylolamides, triethyl citrate, chlorhexidine etc.

Suitable photofilter active ingredients are substances which absorb UV rays in the UV-B and/or UV-A region. Suitable UV filters are, for example, 2,4,6-triaryl-1,3,5-triazines in which the aryl groups may in each case carry at least one substituent which is preferably chosen from hydroxy, alkoxy, specifically methoxy, alkoxycarbonyl, specifically methoxycarbonyl and ethoxycarbonyl and mixtures thereof. Also suitable are p-aminobenzoic esters, cimminic esters, benzophenones, camphor derivatives, and pigments which deflect UV rays, such as titanium dioxide, talc and zinc oxide.

Photoprotective agents suitable for use in the compositions comprising water are all of the compounds specified in EP-A 1 084 696 in the paragraphs [0036] to [0053], which is hereby incorporated in its entirety by reference.

The list of specified UV photoprotective filters which can be used in the preparations according to the invention is not of course intended to be limiting.

Antimicrobial Agents

In addition, antimicrobial agents can also be used in the compositions comprising water. These generally include all suitable preservatives with a specific effect against gram-positive bacteria, e.g. triclosan (2,4,4′-trichlor-2′-hydroxydiphenyl ether), chlorhexidine (1,1′-hexamethylenebis[5-(4-chlorophenyl)biguanide) and TTC (3,4,4′-trichlorocarbanilide).

Quaternary ammonium compounds are in principle likewise suitable, but are preferably used for disinfecting soaps and washing lotions.

Numerous fragrances also have antimicrobial properties. Special combinations with particular effectiveness against gram-positive bacteria are used for the composition of so-called deodorant perfumes.

A large number of essential oils or their characteristic ingredients, such as, for example, oil of cloves (eugenol), mint oil (menthol) or thyme oil (thymol), also exhibit marked antimicrobial effectiveness.

The antibacterially effective substances are generally used in concentrations of from about 0.1 to 0.3% by weight.

Suitable repellant active ingredients are compounds which are able to repel or drive away animals, in particular insects, from people. These include, for example, 2-ethyl-1,3-hexanediol, N,N-diethyl-m-toluamide etc.

Suitable hyperemic substances, which promote circulation in the skin, are, for example, essential oils, such as dwarf pine needle, lavender, rosemary, juniper berry, horse chestnut extract, birch leaf extract, hayflower extract, ethyl acetate, camphor, menthol, peppermint oil, rosemary extract, eucalyptus oil, etc.

Suitable keratolytic and keratoplastic substances are, for example, salicylic acid, calcium thioglycolate, thioglycolic acid and its salts, sulfur, etc.

Suitable antidandruff active ingredients are, for example, sulfur, sulfur polyethylene glycol sorbitan monooleate, sulfur ricinol polyethoxylate, zinc pyrithione, aluminum pyrithione, etc. Suitable antiphlogistics which counteract skin irritations are, for example, allantoin, bisabolol, dragosantol, Camille extract, panthenol, etc. The cosmetic, dermatological or pharmaceutical compositions can comprise, as cosmetic and/or pharmaceutical active ingredient (and also if appropriate as auxiliary), at least one cosmetically or pharmaceutically acceptable polymer.

Preference is given to compositions which additionally comprise at least one nonionic, one anionic, one cationic or one ampholytic polymer.

Anionic polymers preferred as additional polymers are, for example, homopolymers and copolymers of acrylic acid and methacrylic acid and salts thereof. These also include crosslinked polymers of acrylic acid, as are available under the INCI name Carbomer. Such crosslinked homopolymers of acrylic acid are, for example, commercially available under the name Carbopol® (Noveon). Preference is also given to hydrophobically modified crosslinked polyacrylate polymers, such as Carbopol®Ultrez 21 (Noveon),

Further examples of suitable additional anionic polymers are copolymers of acrylic acid and acrylamide and salts thereof, sodium salts of polyhydroxycarboxylic acids, water-soluble or water-dispersible polyesters, polyurethanes and polyureas.

Preference is also given to compositions which additionally comprise a polyurethane as anionic polymer.

Particularly suitable additional polymers are the water-soluble or water-dispersible polyurethanes described in DE 4225045 A1, which is hereby incorporated in its entirety by reference. Of particular suitability is Luviset®P.U.R. (BASF).

In addition, particular preference is given to silicone-containing polyurethanes as are described in DE 19807908 A1, which is hereby incorporated in its entirety by reference. Of particular suitability is Luviset®Si-P.U.R. (BASF).

Particularly suitable polymers are copolymers of (meth)acrylic acid and polyether acrylates, where the polyether chain is terminated with a C₈-C₃₀-alkyl radical. These include, for example, acrylatelbeheneth-25 methacrylate copolymers which are obtainable from Rohm and Haas under the name Aculyn®. Particularly suitable polymers are also copolymers of t-butyl acrylate, ethyl acrytate, methacrylic acid (e.g. Luvimer®100P), copolymers of ethyl acrylate and methacrylic acid (e.g. Luviumer® MAE), copolymers of N-tert-butyl acrylamide, ethyl acrylate, acrylic acid (Ultrahold®8, strong), copolymers of vinyl acetate, crotonic acid and, if appropriate, further vinyl esters (e.g. Luviset® grades), maleic anhydride copolymers, if appropriate reacted with alcohol, anionic polysiloxanes, e.g. carboxyfunctional ones, t-butyl acrylate, methacrylic acid (e.g. Luviskol®VBM), copolymers of acrylic acid and methacrylic acid with hydrophobic monomers, such as, for example, C₄-C₃₀-alkyl esters of meth(acrylic acid), C₄-C₃₀-alkyl vinyl esters, C₄-C₃₀-alkyl vinyl ethers and hyaluronic acid. Examples of anionic polymers are also vinyl acetate/crotonic acid copolymers, as are sold, for example, under the names Resyn® (National Starch) and Gafset® (GAF) and vinylpyrrolidone/vinyl acrylate copolymers obtainable, for example, under the trade name Luviflex® (BASF). Further suitable polymers are the vinylpyrrolidone/acrylate terpolymer available under the name Luviflex®VBM-35 (BASF) and sodium sulfonate-containing polyamides or sodium sulfonate-containing polyesters.

The group of suitable anionic polymers also comprises, by way of example, Balance® CR (National Starch; Acrylate Copolymer), Balance® 0/55 (National Starch; Acrylate Copolymer), Balance® 47 (National Starch; Octylacrylamide/Acrylate/Butylaminoethyl Methacrylate Copolymer), Aquaflex® FX 64 (ISP; IsobutylenelEthyl-maleimide/Hydroxyethylmaleimide Copolymer), Aquaflex® SF-40 (ISP/National Starch; VPNinylcaprolactam/DMAPA Acrylate Copolymer), Allianz® LT-120 (ISP; Rohm & Haas; Acrylate/C1-2 Succinate/Hydroxyacrylate Copolymer), Aquarez® HS (Eastman; Polyester-1), Diaformer® Z-400 (Clariant; Methacryloylethylbetaine/Methacrylate Copolymer), Diaformer® Z-711 (Clariant; Methacryloylethyl N-Oxide/Methacrylate Copolymer), Diaformer® Z-712 (Clariant; Methacryloylethyl N-Oxide/Methacrylate Copolymer), Omnirez® 2000 (ISP; Monoethyl Ester of Poly(Methyl Vinyl Ether/Maleic Acid in Ethanol), Amphomer® HC (National Starch; Acrylate/Octylacrylamide Copolymer), Amphomer® 28-4910 (National Starch; Octylacrylamide/Acrylate/Butyl-aminoethyl Methacrylate Copolymer), Advantage® HC 37 (ISP; Terpolymer of Vinylcaprolactam/Vinylpyrrolidone/Dimethylaminoethyl Methacrylate), Advantage® LC55 and LC80 or LC A and LC E, Advantage® Plus (ISP; VA/Butyl Maleate/Isobornyl Acrylate Copolymer), Aculyne® 258 (Rohm & Haas; Acrylate/Hydroxy Ester Acrylate Copolymer), Luviset® P.U.R. (BASF, Polyurethane-1), Luviflex® Silk (BASF), Eastman® AQ 48 (Eastman), Styleze® CC-10 (ISP; VP/DMAPA Acrylates Copolymer), Styleze® 2000 (ISP; VP/Acrylates/Lauryl Methacrylate Copolymer), DynamX® (National Starch; Polyurethane-14 AMP-Acrylates Copolymer), Resyn® XP (National Starch; Acrylates/Octylacrylamide Copolymer), Fixomer® A-30 (Ondeo Nalco; Polymethacrylic Acid (and) Acrylamidomethylpropanesulfonic Acid), Fixate® G-100 (Noveon; AMP-Acrylates/Allyl Methacrylate Copolymer).

Suitable additional polymers are also the terpolymers of vinylpyrrolidone, C₁-C₁₀-alkyl, cycloalkyl and aryl (meth)acrylates and acrylic acid described in U.S. Pat. No. 3,405,084, Suitable additional polymers are also the terpolymers of vinylpyrrolidone tert-butyl meth)acrylate and (meth)acrylic acid described in EP-A-0 257 444 and EP-A-0 480 280. Suitable additional polymers are also the copolymers described in DE-A-42 23 066 which comprise at least one (meth)acrylic ester, (meth)acrylic acid, and N-vinylpyrrolidone and/or N-vinylcaprolactam in copolymerized form. The disclosure of these documents is hereby incorporated by reference.

Suitable polymers contain carboxylic acid groups are also polyurethanes containing carboxylic acid groups.

EP-A-636361 discloses suitable block copolymers with polysiloxane blocks and polyurethane/polyurea blocks which have carboxylic acid and/or sulfonic acid groups. Suitable silicone-containing polyurethanes are also described in WO 97/25021 and EP-A-751 162. Suitable polyurethanes are also described in DE-A-42 25 045, which is hereby incorporated in its entirety by reference.

These polyurethanes are in principle constructed from
i) at least one compound which comprises two or more active hydrogen atoms per molecule,
ii) at least one diol comprising carboxylic acid groups, or a salt thereof and
iii) at least one polyisocyanate.

Component i) is, for example, a diol, diamine, amino alcohol, or mixture thereof. The molecular weight of these compounds is preferably in a range from about 56 to 280. If desired, up to 3 mol % of said compounds can be replaced by triols or triamines.

Diols i) which can be used on, for example, ethylene glycol, propylene glycol, butylene glycol, neopentyl glycol, cyclohexanedimethylol, di-, tri-, tetra-, penta- or hexaethylene glycol and mixtures thereof. Preference is given to using neopentyl glycol and/or cyclohexanedimethylol. Suitable amino alcohols i) are, for example, 2-aminoethanol, 2-(N-methylamino)ethanol, 3-aminopropanol, 4-aminobutanol, 1-ethylaminobutan-2-ol, 2-amino-2-methyl-1-propanol, 4-methyl-4-aminopentan-2-ol etc. Suitable diamines i) are, for example, ethylenediamine, propylenediamine, 1,4-diaminobutane, 1,5-diaminopentane and 1,6-diaminohexane, and a,w-diaminopolyethers which can be prepared by amination of polyalkylene oxides with ammonia.

Component i) may also be a polymer with a number-average molecular weight in the range from about 300 to 5000, preferably about 400 to 4000, in particular 500 to 3000. Polymers i) which can be used are, for example, polyesterdiols, polyetherols and mixtures thereof. Polyetherols are preferably polyalkylene glycols, e.g. polyethylene glycols, polypropylene glycols, polytetrahydrofurans etc., block copolymers of ethylene oxide and propylene oxide or block copolymers of ethylene oxide, propylene oxide and butylene oxide, which comprise the copolymerized alkylene oxide units in random distribution or in the form of blocks. Suitable polytetrahydrofurans i) can also be prepared by cationic polymerization of tetrahydrofuran in the presence of acidic catalysts, such as, for example, sulfuric acid or fluorosulfuric acid. Such preparation methods are known to the person skilled in the art. Polyesterdiols i) which can be used preferably have a number-average molecular weight in the range from about 400 to 5000, preferably 500 to 3000, in particular 600 to 2000. Suitable polyesterdiols i) which can be used are all those which are usually used for producing polyurethanes, in particular those based on aromatic dicarboxylic acids, such as terephthalic acid, isophthalic acid, phthalic acid, Na or K sulfoisophthalic acid etc., aliphatic dicarboxylic acids, such as adipic acid or succinic acid etc., and cycloaliphatic dicarboxylic acids, such as 1,2-, 1,3- or 1,4-cyclohexanedicarboxylic acid. Suitable diols are, in particular, aliphatic diols, such as ethylene glycol, propylene glycol, 1,6-hexanediol, neopentyl glycol, diethylene glycol, polyethylene glycols, polypropylene glycols, 1,4-dimethylolcyclohexane, etc.

Suitable compounds ii) which have two active hydrogen atoms and at least one carboxylic group per molecule are, for example, dimethylolpropanoic acid and mixtures which comprise dimethylolpropanoic acid.

Component iii) is a customary aliphatic, cycloaliphatic and/or aromatic polyisocyanate, such as tetramethylene diisocyanate, hexamethylene diisocyanate, methylenediphenyl diisocyanate, 2,4- and 2,6-tolylene diisocyanate, and isomer mixtures thereof, o- and m-xylylene diisocyanate, 1,5-naphthylene diisocyanate, 1,4-cyclohexylene diisocyanate, dicyclohexylmethane diisocyanate and mixtures thereof in particular isophorone diisocyanate and/or dicyclohexylmethane diisocyanate. If desired, up to 3 mol % of said compounds can be replaced by triisocyanates.

Suitable additional polymers are also cationic polymers. These include, for example, polymers with the INCI name Polyquaternium, e.g. copolymers of vinylpyrrolidone/N-vinylimidazolium salts (Luviquat® FC, Luviquat® HM, Luviquat® MS, Luviquat® Care), copolymers of N-vinylpyrrolidone/dimethylaminoethyl methacrylate, quaternized with diethyl sulfate (Luviquat® PQ 11), copolymers of N-vinylcaprolactam/N-vinylpyrrolidone/N-vinylimidazolium salts (Luviquat®Hold); cationic cellulose derivatives (Polyquaternium-4 and -10), acrylamido copolymers (Polyquaternium-7) and chitosan. Suitable cationic (quaternized) polymers are also Merquat® (polymer based on dimethyidiallylammonium chloride), Gafquat® (quaternary polymers which form by the reaction of polyvinylpyrrolidone with quaternary ammonium compounds), polymer® JR (hydroxyethylcellulose with cationic groups) and plant-based cationic polymers, e.g. guar polymers, such as the Jaguar® grades from Rhodia.

Suitable additional polymers are also amphoteric or zwitterionic polymers, such as the octylacrylamide/methyl methacrylate/tert-butylaminoethyl methacrylate/2-hydroxypropyl methacrylate copolymers obtainable under the names Amphomer® (National Starch) and zwitterionic polymers, as are described, for example, in the German patent applications DE 39 29 973, DE 21 50 557, DE 28 17 369 and DE 37 08 451. Acrylamidopropyltrimethylammonium chloride/acrylic acid or methacrylic acid copolymers and the alkali metal and ammonium salts thereof are preferred zwitterionic polymers. Further suitable zwitterionic polymers are methacroylethylbetaine/methacrylate copolymers which are commercially available under the name Amersette® (AMERCHOL), and copolymers of hydroxyethyl methacrylate, methyl methacrylate, N,N-dimethylaminoethyl methacrylate and acrylic acid (Jordapon®).

Neutral polymers suitable as additional polymers are, for example, polyvinylpyrrolidones, copolymers of N-vinylpyrrolidone and vinyl acetate and/or vinyl propionate, polysiloxanes, polyvinylcaprolactam and other copolymers with N-vinylpyrrolidone, polyethyleneimines and salts thereof, polyvinylamines and salts thereof, cellulose derivatives, polyaspartic acid salts and derivatives. These include, for example, Luviflex® Swing (partially saponified copolymer of polyvinyl acetate and polyethylene glycol, BASF).

Suitable polymers are also nonionic, water-soluble or water-dispersible polymers or oligomers, such as polyvinylcaprolactam, e.g. Luviskol®Plus (BASF), or polyvinylpyrrolidone and copolymers thereof, in particular with vinylesters, such as vinyl acetate, e.g. Luviskol®VA 37 (BASF); polyamides, e.g. based on itaconic acid and aliphatic diamines, as are described, for example, in DE-A-43 33 238.

Suitable polymers are also nonionic, siloxane-containing, water-soluble or -dispersible polymers, e.g. polyethersiloxanes, such as Tegopren® (Goldschmidt) or Belsil® (Wacker).

The mixtures according to the invention can also be used for modifying the rheology of skin-cleansing compositions.

Skin-cleansing compositions are soaps of liquid to gel-like consistency, such as transparent soaps, luxury soaps, deodorant soaps, cream soaps, baby soaps, skin protection soaps, abrasive soaps and syndets, pasty soaps, soft soaps and washing pastes, liquid washing, showering and bathing preparations, such as washing lotions, shower baths and gels, foam baths, oil baths and scrub preparations, shaving foams, lotions and creams.

The mixtures according to the invention can also be used for modifying the rheology of cosmetic compositions for the care and protection of the skin, nail care compositions or preparations for decorative cosmetics.

Suck skin cosmetic compositions are, for example, face toners, face masks, deodorants and other cosmetic lotions. Compositions for use in decorative cosmetics comprise, for example, concealing sticks, stage make-up, mascara and eye shadows, lipsticks, kohl pencils, eyeliners, blushers, powder and eyebrow pencils.

Furthermore, the polymer mixtures according to the invention can be used in nose strips for pore cleansing, in antiacne compositions, repellents, shaving compositions, hair-removal compositions, intimate care compositions, foot care compositions, and in baby care.

The skin care compositions are, in particular, W/O or O/W skin creams, day and night creams, eye creams, face creams, antiwrinkle creams, moisturizing creams, bleach creams, vitamin creams, skin lotions, care lotions and moisturizing lotions.

Skin cosmetic and dermatological compositions comprise preferably 0.1 to 20% by weight, preferably 0.5 to 15% by weight, very particularly preferably 0.5 to 10% by weight, of the polymer mixture, based on the total weight of the composition.

Particularly photoprotective agents for whose rheology modification with polymer mixtures a) are used have the property of increasing the residence time of the UV-absorbing ingredients compared to customary auxiliaries such as polyvinylpyrrolidone.

Depending on the field of use, the compositions can be applied in a form suitable for skin care, such as, for example, in the form of a cream, foam, gel, stick, mousse, milk, spray (pump spray or propellant-containing spray) or lotion.

Besides the rheology-modifying polymer mixture and suitable carriers, the skin cosmetic preparations can also comprise further active ingredients and auxiliaries customary in skin cosmetics and as described above. These include preferably emulsifiers, preservatives, perfume oils, cosmetic active ingredients, such as phytantriol, vitamin A, E and C, retinol, bisabolol, panthenol, photoprotective agents, bleaches, colorants, tinting agents, tanning agents, collagen, protein hydrolysates, stabilizers, pH regulators, dyes, salts, other thickeners, gel formers, consistency regulators, silicones, humectants, refatting agents and further customary additives.

Preferred oil and fat components of the skin cosmetic and dermatological compositions are the abovementioned mineral and synthetic oils, such as, for example, paraffins, silicone oils and aliphatic hydrocarbons having more than 8 carbon atoms, animal and vegetable oils, such as, for example, sunflower oil, coconut oil, avocado oil, olive oil, lanoline, or waxes, fatty acids, fatty acid esters, such as, for example, triglycerides of C₆-C₃₀-fatty acids, wax esters, such as, for example, jojoba oil, fatty alcohols, Vaseline, hydrogenated lanoline and acetylated lanoline, and mixtures thereof.

To establish certain properties, such as, for example, improving the feel to the touch, the spreading behavior, the water resistance and/or the binding of active ingredients and auxiliaries, such as pigments, the skin cosmetic and dermatological preparations can additionally also comprise conditioning substances based on silicone compounds. Suitable silicone compounds are, for example, polyalkylsiloxanes, polyarylsiloxanes, polyarylalkylsiloxanes, polyethersiloxanes or silicone resins.

The cosmetic or dermatological preparations are produced by customary methods known to the person skilled in the art.

Preferably, the cosmetic and dermatological compositions are in the form of emulsions, in particular water-in-oil (W/O) or oil-in-water (OW) emulsions. However, it is also possible to choose other types of formulation, for example hydrodispersions, gels, oils, oleogels, multiple emulsions, for example in the form of W/O/W or O/W/O emulsions, anhydrous ointments or ointment bases, etc.

Emulsions are produced by known methods. Besides at least one copolymer according to the invention, the emulsions usually comprise customary constituents, such as fatty alcohols, fatty acid esters and, in particular, fatty acid triglycerides, fatty acids, lanoline and derivatives thereof, natural or synthetic oils or waxes and emulsifiers in the presence of water. The selection of the additives specific to the type of emulsion and the preparation of suitable emulsions is described, for example, in Schrader, Grundlagen und Rezepturen der Kosmetika [Fundamentals and formulations of cosmetics], Hüthig Buch Verlag, Heidelberg, 2nd Edition, 1989, third part, which is hereby expressly incorporated by reference.

A suitable emulsion, erg. for a skin cream etc., generally comprises an aqueous phase which has been emulsified by means of a suitable emulsifier system in an oil or fatty phase.

Preferred fatty components which may be present in the fatty phase of the emulsions are: hydrocarbon oils, such as paraffin oil, purcellin oil, perhydrosqualene and solutions of microcrystalline waxes in these oils; animal or vegetable oils, such as sweet almond oil, avocado oil, calophylum oil, lanoline and derivatives thereof, castor oil, sesame oil, olive oil, jojoba oil, karité oil, hoplostethus oil; mineral oils whose distillation starting point under atmospheric pressure is at about 250° C. and whose distillation end point is at 410° C., such as, for example, Vaseline oil; esters of saturated or unsaturated fatty acids, such as alkyl myristates, e.g. i-propyl, butyl or cetyl myristate, hexadecyl stearate, ethyl or isopropyl palmitate, octanoic or decanoic acid triglycerides and cetyl ricinoleate.

The fatty phase can also comprise silicon oils soluble in other oils, such as dimethylpolysiloxane, methylphenylpolysiloxane and the silicone glycol copolymer, fatty acids and fatty alcohols.

In addition, it is also possible to use waxes, such as, for example, carnauba wax, candililla wax, beeswax, microcrystalline wax, ozocerite wax and Ca, Mg and Al oleates, myristates, linoleates and stearates.

In addition, an emulsion may be in the form of a O/W emulsion. Such an emulsion usually comprises an oil phase, emulsifiers which stabilize the oil phase in the water phase, and an aqueous phase which is usually present in thickened form. Suitable emulsifiers are preferably O/W emulsifiers, such as polyglycerol esters, sorbitan esters or partially esterified glycerides.

According to a further preferred embodiment, the rheology-modifying polymer mixtures a) or b) are used in shower gels, shampoo formulations or bath preparations.

Furthermore, such formulations usually comprise anionic surfactants as base surfactants and amphoteric and/or nonionic surfactants as cosurfactants. Further suitable active ingredients and/or auxiliaries are generally chosen from lipids, perfume oils, fat dyes, organic acids, preservatives and antioxidants, and also thickeners/gel formers, skin conditioners and moisturizers.

These formulations advantageously comprise 2 to 50% by weight, preferably 5 to 40% by weight, particularly preferably 8 to 30% by weight, of surfactants, based on the total weight of the formulation.

In the washing, showering and bathing preparation it is possible to use all of the anionic, neutral, amphoteric or cationic surfactants customarily used in body-cleansing compositions.

Suitable anionic surfactants are, for example, alkyl sulfates, alkyl ether sulfates, alkylsulfonates, alkylarylsulfonates, alkyl succinates, alkylsulfosuccinates, N-alkyl sarcosinates, acyl taurates, acyl isothionates, alkyl phosphates, alkyl ether phosphates, alkyl ether carboxylates, alpha-olefinsulfonates, in particular the alkali metal and alkali earth metal salts, e.g. sodium, potassium, magnesium, calcium, and ammonium and triethanolamine salts. The alkyl ether sulfates, alkyl ether phosphates and alkyl ether carboxylates can have between 1 and 10 ethylene oxide or propylene oxide unit, preferably 1 to 3 ethylene oxide units, in the molecule.

These include, for example, sodium lauryl sulfate, ammonium lauryl sulfate, sodium lauryl ether sulfate, ammonium lauryl ether sulfate, sodium lauryl sarcosinate, sodium oleyl succinate, ammonium lauryl sulfosuccinate, sodium dodecylbenzenesulfonate, triethanolamine dodecylbenzenesulfonate.

Suitable amphoteric surfactants are, for example, alkylbetaines, alkylamidopropylbetaines, alkylsulfobetaines, alkyl glycinates, alkyl carboxyglycinates, alkylamphoacetates or amphopropionates, alkyl amphodiacetates or amphodipropionates.

For example, cocodimethylsulfopropylbetaine, laurylbetaine, coca4midopropylbetaine or sodium cocamphopropionate can be used.

Suitable nonionic surfactants are, for example, the reaction products of aliphatic alcohols or alkylphenois having 6 to 20 carbon atoms in the alkyl chain, which may be linear or branched, with ethylene oxide and/or propylene oxide. The amount of alkylene oxide is about 6 to 60 mols per mole of alcohol. In addition, alkylamine oxides, mono- or dialkylalkanolamides, fatty acid esters of polyethylene glycols, ethoxylated fatty acid amides, alkyl polyglycosides or sorbitan ether esters are suitable.

In addition, the washing, showering and bathing preparations can comprise customary cationic surfactants, such as, for example, quaternary ammonium compounds, for example cetyltrimethylammonium chloride.

In addition, the shower gel/shampoo formulations can comprise further thickeners, such as, for example, sodium chloride, PEG-55, propylene glycol oleate, PEG-120 methylglucose dioleate and others, and also preservatives, further active ingredients and auxiliaries and water.

A particularly preferred embodiment of the invention is hair-treatment compositions.

Hair-treatment compositions preferably comprise a polymer mixture a) or polymer b) in an amount in the range from about 0.1 to 20% by weight, preferably 0.5 to 15% by weight, based on the total weight of the composition.

Preferably, the hair-treatment compositions according to the invention are in the form of a setting foam, hair mousse, hair gel, shampoo, hairspray, hair foam, end fluids, neutralizers for permanent waves, hair colorants and bleaches or hot-oil treatments. Depending on the field of use, the hair cosmetic preparations can be applied in the form of an (aerosol) spray, (aerosol) foam, gel, gel spray, cream, lotion or wax. Here, hairsprays comprise both aerosol sprays and also pump sprays without propellant gas. Hair foams comprise both aerosol foams and also pump foams without propellant gas. Hairsprays and hair foams comprise preferably predominantly or exclusively water-soluble or water-dispersible components. If the compounds used in the hairsprays and hair foams according to the invention are water-dispersible, they can be used in the form of aqueous microdispersions with particle diameters of from usually 1 to 350 nm, preferably 1 to 250 nm. The solids contents of these preparations here are usually in a range from about 0.5 to 20% by weight. These microdispersions generally require no emulsifiers or surfactants for their stabilization.

In a preferred embodiment of the invention, the compositions according to the invention comprise a fraction of volatile organic components (VOCs) of at most 80% by weight, particularly preferably at most 55% by weight.

The hair cosmetic formulations according to the invention comprise, in a preferred embodiment,

a) 0.05 to 20% by weight of at least one styling, conditioning or setting polymer,

b) 20 to 99.95% by weight of water and/or alcohol,

c) 0 to 50% by weight of at least one propellant gas,

d) 0 to 5% by weight of at least one emulsifier,

e) 0 to 3% by weight of polymer mixture a) or polymer b), and

f) up to 25% by weight of further constituents.

Alcohol is understood as meaning all alcohols customary in cosmetics, e.g. ethanol, isopropanol, n-propanol.

Further constituents are understood as meaning the additives customary in cosmetics, for example propellants, antifoams, interface-active compounds, i.e. surfactants, emulsifiers, foam formers and solubilizers. The interface-active compounds used may be anionic, cationic, amphoteric or neutral. Further customary constituents may also be, for example, preservatives, perfume oils, opacifiers, active ingredients, UV filters, care substances, such as panthenol, collagen, vitamins, protein hydrolysates, alpha- and beta-hydroxycarboxylic acids, protein hydrolysates, stabilizers, pH regulators, dyes, viscosity regulators, gel formers, dyes, salts, humectants, refatting agents, complexing agents and further customary additives.

All ingredients suitable for cosmetic compositions may, if appropriate, also be used for the hair cosmetic compositions. These also include all styling, setting and conditioning polymers known in cosmetics.

To establish certain properties, the preparations can additionally also comprise conditioning substances based on silicone compounds. Suitable silicone compounds are, for example, polyalkylsiloxanes, polyarylsiloxanes, polyarylalkylsiloxanes, polyethersiloxanes, silicone resins or dimethicone copolyols (CTFA) and aminofunctional silicone compounds, such as amodimethicone (CTFA).

Emulsifiers which may be used are all emulsifiers customarily used in hair foams. Suitable emulsifiers may be nonionic, cationic or anionic or amphoteric. Propellants which are particularly suitable for aerosol foams are mixtures of dimethyl ether and, if appropriate halogenated, hydrocarbons, such as propane, butane, pentane or HFC-152 a.

Examples of nonionic emulsifiers (INCI nomenclature) are laureths, e.g. laureth-4; ceteths, e.g. ceteth-1, polyethylene glycol cetyl ether; ceteareths, e.g. ceteareth-25, polyglycol fatty acid glycerides, hydroxylated lecithin, lactyl esters of fatty acids, alkyl polyglycosides.

Examples of cationic emulsifiers are cetyldimethyl-2-hydroxyethylammonium dihydrogenphosphate, cetyltrimonium chloride, cetyltrimonium bromide, cocotrimonium methyl sulfate, quaternium-1 to x (INCI).

Anionic emulsifiers can, for example, be chosen from the group of alkyl sulfates, alkyl ether sulfates, alkylsulfonates, alkylarylsulfonates, alkyl succinates, alkyl sulfosuccinates, N-alkoyl sarcosinates, acyl taurates, acyl isethionates, alkyl phosphates, alkyl ether phosphates, alkyl ether carboxylates, alpha-olefinsulfonates, in particular the alkali metal and alkaline earth metal salts, e.g. sodium, potassium, magnesium, calcium, and ammonium and triethanolamine salts. The alkyl ether sulfates, alkyl ether phosphates and alkyl ether carboxylates can have between 1 and 10 ethylene oxide or propylene oxide units, preferably 1 to 3 ethylene oxide units, in the molecule.

A preparation suitable according to the invention for styling gels can, for example, have the following composition:
a) 0.1 to 10% by weight of at least one styling, conditioning or setting polymer,
b) 80 to 99.85% by weight of water and/or alcohol,
c) 0.01 to 3% by weight, preferably 0.05 to 2% by weight of the polymer mixture a) or b) as gel former,
d) 0 to 20% by weight of further constituents.

The use of the gel formers according to the invention is advantageous if specific rheological or other application-related properties of the gels are to be established. On account of the excellent compatibility with the polymer mixtures a) or polymer b), it is also possible to use further gel formers customary in cosmetics. These include slightly crosslinked polyacrylic acid, for example carbomer (INCI), cellulose derivatives, e.g. hydroxypropylcellulose, hydroxyethylcellulose, cationically modified celluloses, polysaccharides, e.g. xanthan gum, caprylicicapric triglyceride, sodium acrylate copolymers, polyquaternium-32 (and) paraffinum liquidum (INCI), sodium acrylate copolymers (and) paraffinum liquidum (and) PPG-1 trideceth-6, acrylamidopropyltrimonium chloride/acrylamide copolymers, steareth-10 allyl ether acrylate copolymers, polyquaternium-37 (and) paraffinum liquidum (and) PPG-1 trideceth-6, polyquaternium 37 (and) propylene glycol dicaprate dicaprylate (and) PPG-1 trideceth-6, polyquaternium-7, polyquaternium-44.

The polymer mixtures a) and b) can be used as thickeners in shampoos. Preferred shampoo formulations comprise
a) 0.05 to 10% by weight of at least one setting or conditioning polymer,
b) 25 to 94.95% by weight of water,
c) 5 to 50% by weight of surfactant,
d) 0 to 5% by weight of a further conditioning agent,
e) 0.01 to 3% by weight, preferably 0.05 to 2% by weight of the polymer mixture a) or polymer b) as thickener,
f) 0 to 10% by weight of further cosmetic constituents.

In the shampoo formulations, it is possible to use all of the anionic, neutral, amphoteric or cationic surfactants customarily used in shampoos.

Suitable anionic surfactants are, for example, alkyl sulfates, alkyl ether sulfates, alkylsulfonates, alkylarylsulfonates, alkyl succinates, alkyl sulfosuccinates, N-alkoyl sarcosinates, acyl taurates, acyl isothionates, alkyl phosphates, alkyl ether phosphates, alkyl ether carboxylates, alpha-olefinsulfonates, in particular the alkali metal and alkaline earth metal salts, e.g. sodium, potassium, magnesium, calcium, and ammonium and triethanolamine salts. The alkyl ether sulfates, alkyl ether phosphates and alkyl ether carboxylates can have between 1 and 10 ethylene oxide or propylene oxide units, preferably 1 to 3 ethylene oxide units, in the molecule.

For example, sodium lauryl sulfate, ammonium lauryl sulfate, sodium lauryl ether sulfate, ammonium lauryl ether sulfate, sodium lauryl sarcosinate, sodium oleyl succinate, ammonium lauryl sulfosuccinate, sodium dodecylbenzenesulfonate, triethanolamine dodecylbenzenesulfonate are suitable.

Suitable amphoteric surfactants are, for example, alkylbetaines, alkylamidopropylbetaines, alkylsulfobetaines, alkyl glycinates, alkyl carboxyglycinates, alkyl amphoacetates or amphopropionates, alkyl amphodiacetates or amphodipropionates.

For example, cocodimethylsulfopropylbetaine, laurylbetaine, cocamidopropylbetaine or sodium cocamphopropionate can be used.

Suitable nonionic surfactants are, for example, the reaction products of aliphatic alcohols or alkylphenols having 6 to 20 carbon atoms in the alkyl chain, which may be linear or branched, with ethylene oxide and/or propylene oxide. The amount of alkylene oxide is about 6 to 60 mols per mole of alcohol. In addition, alkylamine oxides, mono- or dialkylalkanolamides, fatty acid esters of polyethylene glycols, alkyl polyglycosides or sorbitan ether esters are suitable.

Furthermore, the shampoo formulations can comprise customary cationic surfactants, such as, for example, quaternary ammonium compounds, for example cetyltrimethylammonium chloride.

To achieve certain effects, customary conditioners may be used in the shampoo formulations. These include, for example, the abovementioned cationic polymers with the INCI name Polyquaternium, in particular copolymers of vinylpyrrolidone/N-vinylimidazolium salts (Luviquat® FC, Luviquat® HM, Luviquat® MS, Luviquat® Care), copolymers of N-vinylpyrrolidoneldimethylaminoethyl methacrylate, quaternized with diethyl sulfate (Luviquat® PQ 11), copolymers of N-vinylcaprolactam/N-vinylpyrrolidone/N-vinylimidazolium salts (Luviquat® Hold); cationic cellulose derivatives (Polyquaternium-4 and -10), acrylamide copolymers (Polyquaternium-7). In addition, it is possible to use protein hydrolysates, and conditioning substances based on silicone compounds, for example polyalkylsiloxanes, polyarylsiloxanes, polyarylalkylsiloxanes, polyether siloxanes or silicone resins. Further suitable silicone compounds are dimethicone copolyols (CTFA) and aminofunctional silicone compounds, such as amodimethicones (CTFA). It is also possible to use cationic guar derivatives, such as guar hydroxypropyltrimonium chloride (INCI).

Measurement Methods

The measurement methods depicted below are customary methods known to the person skilled in the art for characterizing polymers and polymer solutions.

a) Determination of K Value

The K values are measured in accordance with Fikentscher, Cellulosechemie [Cellulose chemistry], Vol. 13, pp. 58 to 64 (1932) at 25° C. in aqueous/ethanolic or ethanolic solution and are a measure of the molecular weight. The aqueous/ethanolic or ethanolic solution of the polymers comprises, depending on the polymer from 0.1 g, 0.5 9, 1.0 g, 2.0 g or 5 g of polymer in 100 ml of solution. If the polymers are present in the form of aqueous dispersions, corresponding amounts of the dispersion depending on the polymer content of the dispersion are topped up with ethanol to 100 ml to give the desired polymer concentration in 100 ml of solution.

The K value is measured in an Ubbelohde capillary type I (Schott).

Depending on the polymer to be characterized with regard to its K value, various concentrated solutions are prepared. It is generally within the ability of the person skilled in the art, on the basis of the preparation of the polymers, to approximately estimate the K value range or to approximately determine the K value range through a first preliminary measurement. If appropriate, this is then followed by a second measurement using measurement solutions as given in the table below.

| | | |
|---|---|---|
| K value | Concentration | Solvent |

Measurement solutions of polyvinylamine

| | | |
|---|---|---|
| >120 | 0.1% by wt. | 5% by wt. NaCl in water |
| 120-70 | 0.5% by wt. | completely demineralized water |
| <70-30 | 1.0% by wt. | completely demineralized water |
| <30-20 | 2.0% by wt. | completely demineralized water |
| <20 | 5.0% by wt. | completely demineralized water |

Measurement solutions for polyvinylpyrrolidone

| | | |
|---|---|---|
| >90 | 0.1% by wt. | completely demineralized water |
| 90-30 | 1.0% by wt. | completely demineralized water |

b) Determination of the Viscosity

The viscosity was measured using a Brookfield DV-II viscometer at 25° C. and using different spindles (e.g. given as spindle 4) and rotational speeds (given in rpm=revolutions per minute). The duration of the measurements was 1 minute. The viscosity is given in mPas.

c) Determination of Molecular Weight M_{w}

The weight-average molecular weight M_{w} was determined either by static light scattering (measuring conditions and instruments) or by gel permeation chromatography (solvent and standard given).

c1) Determination of M_{w} of Polyvinylpyrrolidone (Polymer i)

| | |
|---|---|
| Eluent: | Water/acetonitrile (80/20) |
| | +0.15 mol/l of NaCl |
| | +0.03 mol/l of NaH2PO4 |
| | Adjusted to pH = 9 |
| Column temperature: | 23° C. |
| Flow rate: | 0.8 ml/min |
| Injection: | 100 μL of a solution with 1.5 [g/l] |

Sample solutions were filtered through Sartorius Minisart
RC 25 (pore width 0.2 [μm]).

| | | |
|---|---|---|
| Separating columns: | separating material: | Suprema linear M |
| | Internal diameter: | 8 mm |
| | Length: | 30 cm |

| | |
|---|---|
| Plate number of the combination | 40 000 |
| at the given flow rate: | |
| Detector: | UV photometer GAT-LCD 503 at |
| | 208 nm. |

Calibration: Calibration was carried out using PVP samples with K value 90 or 30 and a PVP sample with M_{w} about 9000 g/mol whose integral molecular weight distribution curves had been determined by SEC laser light scatter coupling, in accordance with the calibration method by M. J. R. Cantow et al. (J. Polym. Sci., A-1, 5(1967)1391-1394). The oligomer range was established using a PVP sample with K value 12 with isopropanol end groups and with 2-pyrrolidone.

c2) Determination of M_{w} of Polyvinylformamide (=Precursor of Polymer ii2))

The molar mass M_{w} of polyvinylformamide was determined by static light scattering of a solution of the polymer in 0.1 mol aqueous sodium chloride solution using a customary goniometer (FICA). To evaluate the light scattering data, a refractive index increment dn/dc of 0.168 ml/g is used (determined by differential refractometry). The particular polymer concentration of the solution was chosen to correspond to the scatter intensity of the polymers. The person skilled in the art ascertains the suitable concentration through experimentation with differently concentrated solutions. As a guideline, polymers with small K values (up to about 100) should be used in concentrations of from 1 to 4 g/l, and polymers with large K values should be used in concentrations of from 0.05 to 0.2 g/l. Each measurement was extrapolated to infinite dilution.

c3) Determination of M_{w} of Polyethyleneimines

Instruments:

Pump:

L 6000A; Merck/Hitachi

Columns:

HEMA Bio linear, 40·8 mm 10 μm; PSS Mainz

HEMA Bio 100, 300·8 mm, 10 μm

HEMA Bio 1000, 300·8 mm, 10 μm

HEMA Bio 10 000, 300·8 mm, 10 μm

Detectors:

UV detector SPD-2A; Shimadzu

RI detector ERC 7515A; ERC

Evaluation System:

GPC software; Polymer Standard Service

(PSS) Mainz

Reagents:

Eluent:

1.5% strength formic acid

Internal Standard:

Tertiary-butanol 0.05% strength in 1.5% strength formic acid

Calibration:

Fructose MW=180 g/mol

Pullulan MW=342-1.660.000 g/mol; PSS Mainz

Verification:

Pullulan 10 000 (Mw: 10 000)

Procedure:

Sample Preparation:

Weigh in 0.2 g of 100% strength substance into a 25 ml sample buffer and top up with 20 ml of internal standard solution, dissolve

Flow: 1 ml/min

Sample amount: 20 μl

Sample concentration: 1% in internal standard solution

The invention is described in more detail by reference to the following nonlimiting examples.

### EXAMPLES

### Examples 1 to 15

### Use of Polymer i) and ii2) for Modifying the Rheology of Compositions Comprising Water

Polymer i) Used:

Luviskol® K30: Polyvinylpyrrolidone, K value 30

Polymer ii2) Used:

Luresin™ PR 8086: Polyvinylamine from polyvinylformamide, K value 90, degree of hydrolysis 95%

The aqueous compositions for which viscosities are given in Table 1 below were prepared by mixing 100 g of a 2% by weight polymer-comprising aqueous composition by mixing the corresponding amounts of 2% strength by weight aqueous solutions of Luresin™ PR 8086 and Luviskol® K30, and adjusting the pH to the given value using 25% strength by weight sodium hydroxide solution. The viscosity was determined at 20° C. after 30 minutes.

TABLE 1

| | Weight ratio of | | Viscosity |
|---|---|---|---|
| No. | PVP/polyvinylamine | pH | Sp.6, 10 rpm |
| 1 | 2:1 | 6.9 | 60 000 |
| 2 | 1:1 | 6.9 | 35 000 |
| 3 | 1:1 | 7.0 | 27 000 |
| 4 | 1:1 | 7.2 | 28 000 |
| 5 | 1:1 | 7.4 | 31 000 |
| 6 | 1:1 | 7.7 | 50 000 |

The aqueous compositions whose viscosity is referred to as “thick” or liquid in Table 2 below were prepared by mixing 100 g of a 2% by weight polymer-comprising aqueous composition by mixing the corresponding amounts of 2% strength by weight aqueous solutions of the particular polyvinylamine and polyvinylpyrrolidone, and adjusting the pH to pH 8.1 using 25% strength by weight sodium hydroxide solution.

TABLE 2

| | Polyvinylamine* | PVP* | Weight ratio of | | | Viscosity |
|---|---|---|---|---|---|---|
| | K value/degree of | K | PVP/ | | | Sp.4, |
| No. | hydrolysis | value | polyvinylamine | AS** | pH | 12 rpm |
| 7 | 90/95 | 17 | 1:1 | 2% | 8.1 | liquid |
| 8 | 90/95 | 30 | 1:1 | 2% | 8.1 | thick |
| 9 | 90/95 | 90 | 1:1 | 2% | 8.1 | thick |
| 10 | 60/95 | 90 | 1:1 | 2% | 8.1 | thick |
| 11 | 160/50 | 90 | 1:1 | 2% | 8.1 | thick |
| 12 | 90/95 | 30 | 1:2 | 2% | 8.1 | thick |
| 13 | 90/95 | 30 | 2:1 | 2% | 8.1 | thick |
| 14 | 90/95 | 30 | 10:1 | 2% | 8.1 | thick |
| 15 | 90/95 | 30 | 1:10 | 2% | 8.1 | thick |

*The polyvinylamines used were Luresin ™ grades with a corresponding K value and a degree of hydrolysis and the polyvinylpyrrolidones used were Luviskol ® grades with a corresponding K value;
**AS: % by wt. of active substance (= polymer) in the water-comprising composition

### Example 16

### Preparation of a Polymer of the Polymer ii2) Type in the Presence of a Polymer of the Polymer i) Type

### Example 16.1

### Preparation of a N-vinylformamide Homopolymer

In a 2 l stirred vessel fitted with reflux condenser and anchor stirrer, 175 g of Pluriol®E 1500, 3.0 g of sodium dihydrogenphosphate, 200 g of N-vinylformamide, 25 g of Pluriol®P600, 74 g of Luviskol®K90, 83.3 g of Luviskol®K30 and 426 g of demineralized water were stirred at 200 rpm. The pH was adjusted to 6.75 with 25% strength by weight sodium hydroxide solution. The reaction mixture is heated to 50° C. and freed from oxygen using a continuous stream of nitrogen. Following the addition of 1.2 g of Wako®V50 (2,2-azobis(2-amidinopropane) dihydrochloride) as initiator, the internal temperature was maintained at 50° C. until a timewise constant viscosity of the reaction mixture had been reached.

This gave a white dispersion with a viscosity of about 2500 mPas (Brookfield DV-II, spindle 4, 20 rpm) and a K value of about 160.

### Example 16.2

### Hydrolysis of the Polymer from Example 1.1

1000 g of the dispersion prepared in Example 16.1 was weighed into a 2 l stirred vessel, stirred at 200 rpm and heated to 60° C. 42 g of 96% strength by weight sulfuric acid were continuously metered in over 2 hours. The mixture was then stirred at 60° C. for 5 hours.

This gave a white dispersion with a viscosity of 2500 mPas (Brookfield DV-II, spindle 4, 20 rpm).

Use of the Dispersion for Modifying the Rheology of Compositions Comprising Water

90 g of water were added to 10 g of the dispersion from Example 16.1 and the pH of the aqueous mixture was adjusted to pH 7.4 using 25% strength by weight sodium hydroxide solution. This gave a clear gel with a viscosity of 9000 mPas (Spindle 3, 20 rpm) after 20 minutes.

### Example 17

### Gels with Cationic Polymers

### Example 17.1

0.5 g of polyvinylpyrrolidone (Luviskol®) with differing K value was dissolved, with stirring, in in each case 60 g of water, after which in each case 0.5 g of polyvinylamine (Luresin™ PR 8086) was added with stirring and dissolved. To this were then added, with stirring, in each case 5.5 g of Luviquat®Excellence and 33.5 g of water.

| | |
|---|---|
| Mixture with Luviskol ® K 30: | Gel formation after about 7 days |
| Mixture with Luviskol ® K 90: | Gel formation after about 48 hours |
| Mixture with Luviskol ® K 120: | Gel formation after about 48 hours |

### Example 17.2

0.5 g of polyvinylpyrrolidone (Luviskol®) with differing K value was dissolved, with stirring, in in each case 60 g of water, after which in each case 5.5 g of Luviquate Excellence were added with stirring and dissolved. To this were then added, with stirring, in each case 0.5 g of polyvinylamine (Luresin™ PR 8086) and 33.5 g of water.

| | |
|---|---|
| Mixture with Luviskol ® K 30: | Gel formation after about 12 hours |
| Mixture with Luviskol ® K 90: | Gel formation after about 12 hours |
| Mixture with Luviskol ® K 120: | Gel formation after about 12 hours |

### Example 20

### Use of Polymers i) and ii1) for Modifying the Rheology of Compositions Comprising Water

Polymers i) Used:

Sokalan®HP 50 (BASF). Polyvinylpyrrolidone (PVP), M_{w} about 40.000 g/mol, K value 30

Sokalan®HP 60 (BASF): Polyvinylpyrrolidone, M_{w} about 1.5 million g/mol, K value 95 Sokalan®HP 56 (BASF): Copolymer of vinylimidazole and vinylpyrrolidone, M_{w} about 70.000 g/mol, K value 32

Polymers ii1) Used:

Lupasol®SK (BASF): Modified polyethyleneimine (PEI) M_{w} 2.000.000 g/mol

Lupasol®P (BASF): PEI, M_{w} about 750.000 g/mol

In suitable beakers in each case 50 ml of an 8 and 10% strength by weight (based on solids content) of Sokalan®HP 50 solution were prepared. These Sokalan solutions were adjusted to pH 11 using 25% strength by weight sodium hydroxide solution. In each case 50 ml of a 2% strength by weight (based on solids content) of Lupasol®SK solution (Mw 2.000.000 g/mol) were then added to these solutions. The mixtures were then stirred using magnetic stirrers. If the viscosity of the mixture was too high, a spatula was used for stirring. The mixtures had a pH of 10.

After one and 24 hours the viscosities measured (Brookfield®DVII, measuring time: 1 minute; data regarding spindle size and rotational speed see Table 2).

TABLE 2

| PVP | PEI | | | | | |
|---|---|---|---|---|---|---|
| % by | % by | | Temp. | Viscosity | Viscosity | |
| wt. | wt. | pH | [° C.] | after 1 h | after 24 h | Remarks |
| 4 | 1 | 10 | 20 | 720 | 2112 | Readily |
| | | | | (sp.3/50 | (sp.3/20 rpm) | gel-like after |
| | | | | rpm) | | 1 h |
| 5 | 1 | 10 | 20 | 2490 | 6980 | Immediately |
| | | | | (sp.4/100 | (sp.4/50 rpm) | gel-like |
| | | | | rpm) | | |

### Example 21

In suitable beakers, in each case of 50 ml of a 4, 6, 8 and 10% strength by weight (based on solids content) of Sokalan®HP 50 solution were prepared. These Sokalan solutions were adjusted to pH 11 using 25% strength by weight sodium hydroxide solution.

In each case 50 ml of a 6% strength by weight (based on solids content) of Lupasol®SK solution (Mw 2.000.000g/mol) were added to these solutions. The mixtures were then stirred using magnetic stirrers. If the viscosity of the mixture was too high, a spatula was used for stirring. The mixtures had a pH of 10.

After one and 24 hours, the viscosity is measured (Brookfield®DVII, measuring time: 1 minute; data relating to spindle size and rotational speed see Table 3).

TABLE 3

| PVP | PEI | | | | | |
|---|---|---|---|---|---|---|
| % by | % by | | Temp. | Viscosity | Viscosity | |
| wt. | wt. | pH | [° C.] | after 1 h | after 24 h | Remarks |
| 2 | 3 | 10 | 20 | 71 | 156 | Readily |
| | | | | (sp.2/100 | (sp.2/100 rpm) | gel-like |
| | | | | rpm) | | after 1 h |
| 3 | 3 | 10 | 20 | 1410 | 3725 | Immediately |
| | | | | (sp.3/50 | (sp.4/100 rpm) | gel-like |
| | | | | rpm) | | |
| 4 | 3 | 10 | 20 | 8500 | 20100 | Immediately |
| | | | | (sp.4/50 | (sp.4/20 rpm) | gel-like |
| | | | | rpm) | | |
| 5 | 3 | 10 | 20 | 16250 | 40310 | Immediately |
| | | | | (sp.4/20 | (sp.4/10 rpm) | gel-like |
| | | | | rpm) | | |

At a PEI conc. of 3% by weight, a gel-like mixture formed at a PVP concentration greater than 2% by weight whose viscosity increased sharply again within 24 h. After a PVP conc. of greater than 4% by weight, cut-resistant gels were obtained. All of the mixtures were transparent.

### Example 22

Solubility of the gels in Water

In a beaker in each case, 100 ml if deionized water were initially introduced at room temperature, then 5 g of two different gel compositions were added in each case. The gels were prepared analogously to Examples 20 and 21, the concentrations of the polymers i) and ii1) used and the pH values of the gels being given in Table 4.

The mixture was stirred at room temperature on a magnetic stirrer at moderate speed and the time until the gel had completely dissolved was determined (visual evaluation). A polyethyleneimine with M_{w}=750.000 g/mol (Lupasol®P) was used.

TABLE 4

| PVP | PEI | | Temp. | Time until |
|---|---|---|---|---|
| % by wt. | % by wt. | pH | [° C.] | complete dissolution |
| 10 | 5 | 10 | 20 | 6 hours |
| 10 | 5 | 4 | 20 | 6 hours |

The prepared cut-resistant gels are water-soluble despite a high polymer concentration.

### Example 23

In a beaker in each case, mixtures of a Sokalan®HP 50 or Sokalan®HP 60 solution with a Lupasol®SK or Lupasol®P solution were prepared analogously to Examples 20 and 21. Prior to the addition of the Lupasol® solutions, the Sokalan® solutions were adjusted to a pH using sodium hydroxide solution of hydrochloric acid such that the finished mixtures had the pH given in Table 5.

The mixtures were then stirred using magnetic stirrers. If the viscosity of the mixture is too high, a spatula was used for stirring. After one and 24 hours, the viscosity was measured (Brookfield®DVII, measuring time: 1 minute).

The compositions of the mixtures and results of the viscosity measurements of the compositions are shown in Table 5.

TABLE 5

| | | PEI | | | | Viscosity | Viscosity |
|---|---|---|---|---|---|---|---|
| pH | PVP % by wt. | % by wt. | PVP M_{w} | PEI M_{w} | Temp. | after 1 h | after 24 h |
| 4 | 10 | 5 | 40 000 | 750 000 | 20 | n.m.* | n.m. |
| 10 | 10 | 0.5 | 40 000 | 750 000 | 20 | n.m. | n.m. |
| 10 | 10 | 5 | 40 000 | 2.00E+06 | 20 | 870 000 | n.m. |
| 10 | 10 | 10 | 40 000 | 2.00E+06 | 20 | 800 000 | n.m. |
| 10 | 10 | 0.5 | 1.50E+06 | 2.00E+06 | 20 | 1776 | 1752 |
| 4 | 10 | 5 | 1.50E+06 | 2.00E+06 | 20 | 2244 | 1870 |
| 10 | 10 | 5 | 1.50E+06 | 750000 | 20 | 1242 | 1284 |
| 10 | 5 | 2.5 | 4.00E+04 | 2.00E+06 | 20 | 16 000 | 110 000 |
| 10 | 5 | 5 | 4.00E+04 | 2.00E+06 | 20 | 355 000 | 610 000 |
| 10 | 5 | 10 | 4.00E+04 | 2.00E+06 | 20 | 270 000 | 560 000 |
| 10 | 7.5 | 2.5 | 4.00E+04 | 2.00E+06 | 20 | 120 000 | 500 000 |
| 10 | 10 | 0.5 | 4.00E+04 | 2.00E+06 | 20 | 55 000 | 800 000 |
| 10 | 10 | 5 | 1.50E+06 | 2.00E+06 | 50 | 1281 | 1156 |
| 10 | 10 | 5 | 40 000 | 750 000 | 50 | n.m. | n.m. |
| 4 | 10 | 0.5 | 40 000 | 750 000 | 50 | n.m. | n.m. |
| 4 | 10 | 5 | 40 000 | 2.00E+06 | 50 | 18 170 | 75 000 |

*n.m.: Not measurable; the viscosity of the gels prepared in the thus referenced examples could not be determined using the customary measurement method given above.

The PVP with M_{w} 40 000 used was Sokalan®HP 50, the PVP with M_{w} 1.5 million used was Sokalan®HP 60, the PEI with M_{w} 750 000 used was Lupasol®P and the PEI with M_{w} 2 million used was Lupasol®SK.

Result: The thickening effect takes place in a broad pH and temperature range.

### Example 24

Use of acrylamide copolymers as polymer i) and PEI as polymer ii1) for modifying the rheology of compositions comprising water

The Acrylamide Copolymers Used Were:

Sedipur®AF 100: Acrylamide/Na acrylate copolymer, M_{w}, about 8-11 million

Sedipur®CF 104: Acrylamide/dimethylaminoethyl acrylate copolymer, M_{w} about 8 million

in suitable beakers, in each case 50 ml of a 0.5% strength by weight (based on solids content) of the Sedipur® solutions and 50 ml of a 4 or 10% by weight (based on solids content) Lupasol®SK solution were prepared. These solutions were adjusted to pH 10 using sodium hydroxide solution or to pH 4 using hydrochloric acid.

The Lupasol® solutions were added to the Sedipur® solutions with stirring. The mixtures were then stirred using magnetic stirrers. If the viscosity of the mixture is too high, a spatula is used for stirring.

After one and 24 hours, the viscosity was determined measured (Brookfield®DVII, measuring time: 1 minute; data regarding spindle size and rotation speed see Table 6). Compositions, pH values and the results of the viscosity measurements of the individual water-comprising compositions are given in Table 6.

TABLE 6

| | Sedipur | PEI | Sedipur | Temp. | Viscosity | Viscosity |
|---|---|---|---|---|---|---|
| pH | % by wt. | % by wt. | type | [° C.] | after 1 h | after 24 h |
| 4 | 0.25 | 2 | AF 100 | 20 | 5500 | 1 040 000 |
| | | | | | (sp.4/50) | (sp.4/0.5) |
| 10 | 0.25 | 2 | AF 100 | 20 | 1248 | 7500 |
| | | | | | (sp.4/100) | (sp.4/50) |
| 10 | 0.25 | 2 | CF 104 | 20 | 235 | 25.000 |
| | | | | | (sp.3/100) | (sp.4/10) |
| 4 | 0.25 | 5 | AF 100 | 20 | 7280 | 226 000 |
| | | | | | (sp.4/50) | (sp.4/2) |
| 10 | 0.25 | 5 | AF 100 | 20 | 9300 | 740 000 |
| | | | | | (sp.4/100) | (sp.4/0.5) |
| 10 | 0.25 | 5 | CF 104 | 20 | 1880 | 191 000 |
| | | | | | (sp.4/100) | (sp.4/2) |

### Example 25

### Embedding Active Ingredients Into the Gel Matrix Color Transfer Inhibitor as Active Ingredient

A 20% strength Lupasol®P solution was prepared in a beaker. In a further beaker, 3.75 g of demineralized water and 15 g of Sokalan®HP 50 (10% by weight active substance in distilled water) were mixed together in a further beaker. Then, 15 g of Sokalan®HP 56 (vinylpyrrolidonelvinylimidazole copolymer solution, M_{w} 70.000 g/mol, 30% by wt. active substance in distilled water) are added mixed. 11.25 g of a 20% strength by weight Lupasol® solution were then added. A high-viscosity gel formed whose viscosity was determined by the method given above.

### Example 26

### Embedding Surfactants Into the Gel Matrix

In a beaker, 50 g of a 20% strength by weight Sokalan®HP 50 solution and 20 g of Lutensol®A07 (C₁₃C₁₅-fatty alcohol ethoxylate with 7 ethylene oxide, 100% strength) were mixed together. Then, with stirring, 50 g of a 20% strength by weight Lupasol®P solution were added. A transparent, cut-resistant gel was formed whose very high viscosity could not be determined using the method given above.

### Example 27

### Preparation of a Polymer b) Suitable as Thickener

VP/Plex®6877-O/TBAEMA/AMPS [70:20:4.75:5.25]

(Plex® 6877-O (Röhm): C16-18-alkyl-(EO)25-MA 25% in MMA, TBAEMA: N-tert-butylaminoethyl methacrylate, VI: vinylimidazole MAA: methacrylic acid)

| Initial charge: | 128 g | Water |
|---|---|---|
| | 44 g | Ethanol |
| | 9.25 g | Feed 1 |
| | 5.25 g | Feed 2 |
| Feed 1: | Monomer mixture of: | |
| | 105 g | Vinylpyrrolidone |
| | 30 g | Plex ® 6877-O |
| | 7.13 g | TBAEMA |
| | 7.9 g | AMPS |
| | 35 g | Ethanol |
| Feed 2: | 0.15 g | Wako 50 [2,2′-azobis(2-amindinopropane) |
| | | dihydrochloride] |
| | 105 g | Water |
| Feed 3: | 0.75 g | tert-Butyl perpivalate 75% strength |
| | 38.5 g | Ethanol |
| Feed 4: | 100 g | Ethanol |

9.25 g of feed 1, 525 g of feed 2, 44 g of ethanol and 128 g of water were initially introduced into a stirred apparatus fitted with reflux condenser, internal thermometer and three separate feed devices and the mixture was heated to about 65° C. with stirring. After the onset of polymerization, recognizable from the viscosity starting to increase, at 65° C., the remainder of feed 1 was added over the course of three hours and the remainder of feed 3 was added over the course of four hours, during which the internal temperature was increased to about 68° C. The reaction solution was after-stirred for about a further two hours at 68° C. Feed 3 was then metered in over the course of 30 minutes. Following the addition, after-polymerization was carried out for about a further two hours at a temperature of about 80° C. This subsequently gave an approximately 30% by weight aqueous microdispersion.

For stabilization, the solution was admixed with 100 ppm of Euxyl®K100 (5-chloro-2-methyl-3-(2H)-isothiazolone/2-methyl-3-(2H)-isothiazolone/benzyl alcohol (Schülke & Mayr)).

| | | | | | | | K value |
|---|---|---|---|---|---|---|---|
| Example | | Plex ® | | | | | (1% in |
| No. | VP | 6877-O | TBAEMA | VI | AMPS | MAA | NMP) |
| 27 | 70 | 20 | 4.75 | — | 5.25 | — | 99.4 |
| 28 | 70 | 10 | 9.5 | — | 10.5 | — | 72.4 |
| 29 | 60 | 20 | — | 11 | — | 9 | 82.1 |
| 30 | 50 | 10 | — | 22 | | 18 | 79.2 |

The polymers b) of Examples 28, 29 and 30 were prepared analogously to Example 27.

Examples of Cosmetic Preparations

Unless expressly noted otherwise, the quantitative data below are in % by weight. The amounts of the polymers used according to the invention are given as solid in % by weight of polymer. If the polymer is used in the form of a solution or dispersion, it is necessary to use the amount of solution or dispersion corresponding to the amount of polymer required (according to the data in the following examples).

A1) Hair Gel

1.5% Luresin™ PR 8086 (K value 90, degree of hydrolysis 95%)

0.5% Luviskol™ K30

3% Luviskol™ K90

0.50% Panthenol

q.s. Perfume oil

q.s. Preservative

ad 100% Water

A2) Hair Gel

1.5% Luresin™ PR 8086

0.5% Luviskol K30

2.5% Luviskol™ K90

0.5% Luviquat™ Hold

0.50% Panthenol

q.s. Perfume oil

q.s. Preservative

ad 100% Water

A3) Hair Gel

1.5% Luresin™ PR 8086

0.5% Luviskol K30

2.5% Luviskol™ K90

0.5% Luviquat™ Supreme

0.50% Panthenol

q.s. Perfume oil

q.s. Preservative

ad 100 % Water

A4) Hair Gel

1.5% Luresin™ PR 8086

0.5% Luviskol K30

2.0% Luviskol™ K90

1% Luviquat™ Hold

0.50% Panthenol

q.s. Perfume oil

10 q.s. Preservative

ad 100% Water

A5) Hair Gel

1.5% Luresin™ PR 8086)

0.5% Luviskol K30

2.0% Luviskol™ K90

1% Luviset™ Clear

0.50% Panthenol

q.s. Perfume oil

q.s. Preservative

ad 100% Water

A6) Hair Gel

1.5% Luresin™ PR 8086

0.5% Luviskol K30

2.0% Luviskol™ K90

1% Polyquaternium 11

0.50% Panthenol

q.s, Perfume oil

q.s. Preservative

ad 100% Water

Instead of the combinations of polymer i) (Luviskol™) and ii) (Luresin™ PR 8086 or other polyvinylamines) specified in the examples above, the following combinations of polymers i) and ii) can also be used successfully:

0.5% Luresin™ PR 8086

1.5% Luviskol™ K30

1.5% Luresin™ PR 8086

0.5% Luviskol™ K90

0.5% Luresin™ PR 8086

1.5% Luviskol™ K90

0.5% Polyvinylamine with K value 60 and a degree hydrolysis 95 (=60/95)

1.5% Luviskol™ K90

1.5% Polyvinylamine with K value 60 and degree of hydrolysis 95

0.5% Luviskol™ K90

0.5% Polyvinylamine with K value 60 and degree of hydrolysis 95

1.5% Luviskol™ K30

1.5% Polyvinylamine with K value 60 and degree of hydrolysis 95

0.5% Luviskol™ K30

0.5% Polyvinylamine with K value 60 and degree of hydrolysis 50

1.5% Luviskol™ K30

1.5% Polyvinylamine with K value 160 and degree of hydrolysis 50

0.5% Luviskol™ K30

0.5% Polyvinylamine with K value 160 and degree of hydrolysis 50

1.5% Luviskol™ K90

1.5% Polyvinylamine with K value 160 and degree of hydrolysis 50

0.5% Luviskol™ K90

2% Luresin™ PR 8086

0.3% Luviskol™ K30

2% Luresin™ PR 8086

0.3% Luviskol™ K90

2% Polyvinylamine with K value 60 and degree of hydrolysis 95

0.3% Luviskol™ K90

2% Polyvinylamine with K value 60 and degree of hydrolysis 95

0.3% Luviskol™ K30

2% Polyvinylamine with K value 160 and degree of hydrolysis 50

0.3% Luviskol™ K30

2% Polyvinylamine with K value 160 and degree of hydrolysis 50

0.3% Luviskol™ K90

1-19. (canceled)

20. A thickening water-containing composition, comprising:
a) a mixture of
i) at least one polymer comprising amide groups and
ii) at least one amino group-containing polymer, where the amino group-containing polymer comprises structural units of the general formula III, 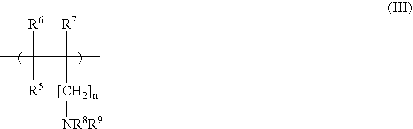
where
R⁵ to R⁹, independently of one another, are hydrogen, C₁-C₆-alkyl, -aryl or -alkylaryl or R⁸ and R⁹ together with the nitrogen atom to which they are bonded can form a 5 to 8-membered N-heterocycle and
n is 0,1,2,3 or 4,
and where the weight ratio of the sum of the monomer building blocks of polymer i) carrying the amide groups to the sum of the monomer building blocks of polymer ii carrying the amino groups is in the range less than 27:1 to 1:30 or
with the proviso that i) comprises less than 0.49% by weight of acrolein based on the total weight of i) in copolymerized and/or grafted form,
wherein the composition is effective for modifying the rheology of compositions comprising water.

21. The thickening water-containing composition according claim 20, where polymer i) comprises α,β-ethylenically unsaturated amide group-containing compounds of the general formula I in copolymerized form, 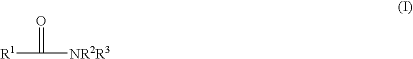
where
R¹ is a group of the formula CH₂═CR⁴— where R⁴═H or C₁-C₄-alkyl and R² and R³, independently of one another, are H, alkyl, aminoalkyl, cycloalkyl, heterocycloalkyl, aryl or hetaryl, or R² and R³ together with the nitrogen atom to which they are bonded are a five- to eight-membered heterocycle,
or R² is a group of the formula CH₂═CR⁴— and R¹ and R³, independently of one another, are H, alkyl, cycloalkyl, heterocycloalkyl, aryl or hetaryl, or R¹ and R³ together with the amide group to which they are bonded are a lactam having 5 to 8 ring atoms.

22. The thickening water-containing composition according to claim 20, where polymer i) comprises (meth)acrylamide and/or N-vinyllactams in copolymerized form.

23. The thickening water-containing composition according to claim 20, where polymer i) comprises at least one monomer chosen from the group consisting of acrylamide, the N-vinyl derivatives of optionally alkyl-substituted 2-pyrrolidone, optionally alkyl-substituted 2-piperidone and optionally alkyl-substituted ε-caprolactam.

24. The thickening water-containing composition according to claim 20, where polymer i) comprises at least one monomer chosen from the group consisting of the N-vinyl derivatives of 2-pyrrolidone, 3-methyl-2-pyrrolidone, 4-methyl-2-pyrrolidone, 5-methyl-2-pyyrolidone, pyrrolidone, 3-ethyl-2-pyrrolidone, 3-propyl-2-pyrrolidone, 3-butyl-2-pyrrolidone, 3,3-dimethyl-2-pyrrolidone, 3,5-dimethyl-2-pyrrolidone, 5,5-dimethyl-2-pyrrolidone, 3,3,5-trimethyl-2-pyrrolidone, 5-methyl-5-ethyl-2-pyrrolidone, 3,4,5-trimethyl-2-pyrrolidone, 3-methyl-2-piperidone, 4-methyl-2-piperidone, 5-methyl-2-piperidone, 6-methyl-2-piperidone, 6-ethyl-2-piperidone, 3,5-dimethyl-2-piperidone, 4,4-dimethyl-2-piperidone, 3-methyl-ε-caprolactam, 4-methyl-ε-caprolactam, 5-methyl-ε-caprolactam, 6-methyl-ε-caprolactam, 7-methyl-ε-caprolactam, 3-ethyl-ε-caprolactam, 3-propyl-ε-caprolactam, 3-butyl-ε-caprolactam, 3,3-dimethyl-ε-caprolactam, 7,7-dimethyl-ε-caprolactam and mixtures thereof in copolymerized form.

25. The thickening water-containing composition according to claim 20, where R⁵ to R⁹ are hydrogen and n is 0 or 1.

26. The thickening water-containing composition according to claim 20, where polymer ii) is chosen from the group consisting of at least partially hydrolyzed homo- and copolymers of N-vinylformamide, N-vinylacetamide or N-methyl-N-vinylacetamide.

27. The thickening water-containing composition according to claim 20, where
i) the K value of i) is in the range from greater than 17 to 170 and
ii) the molecular weight Mw of ii) is in the range from 80 000 to 3 million g/mol.

28. The thickening water-containing composition according to claim 26, where polymer ii) is obtainable by
a) 80 to 100% hydrolysis of the vinylcarboxamide units of a poly-N-vinylcarboxamide with a K value in the range between 45 and 90 or
b) 20 to 80% hydrolysis of the vinylcarboxamide units of a poly-N-vinylcarboxamide with a K value in the range from 90 to 200.

29. The thickening water-containing composition according to claim 20, where the composition comprising water is a cosmetic or pharmaceutical preparation.

30. The thickening water-containing composition according to claim 20, where the composition comprising water is a liquid detergent.

31. A method of modifying the rheology of compositions comprising water, comprising at least one of the steps
a) adding the polymers i) and ii) as defined in claim 20 to the composition comprising water where the weight ratio of i) to ii) is in the range from less than 27:1 to 1:30 and where the polymers i) and ii) are present separately prior to the addition and where the addition takes place simultaneously or not simultaneously;
b) adding a mixture of the polymers i) and ii) as defined in claim 20 to the composition comprising water where the weight ratio i) to ii) is in the range from less than 27:1 to 1:30.

32. The method according to claim 31, wherein the pH of the composition comprising water after the at least one step a) or b) as in claim 31 is adjusted to a value greater than 3 and less than 11.

33. The method according to claim 31, wherein the method is carried out at a temperature greater than 15° C. and less than 95° C.

34. The method according to claim 31, where the total amount of the polymers i), ii) added to the composition comprising water in the at least one step a) to b) is 0. 1 to 20% by weight, based on the total weight of the composition comprising water.

35. The method according to claim 31, wherein
i) a water-comprising composition comprising 0.05 to 10% by weight of polymer i) is combined with
ii) a 0.05 to 10% by weight strength aqueous solution of polymer ii), with the proviso that the weight ratio of polymer i) to polymer ii) is in the range from 20:1 to 1:10.

36. A composition comprising water obtainable by the method according to claim 34.

37. A mixture of
i) at least one polymer containing amide groups having a K value in the range from greater than 17 to 170 and
ii) at least one amino group-containing polymer, where the amino group-containing polymer comprises structural units of the general formula III, 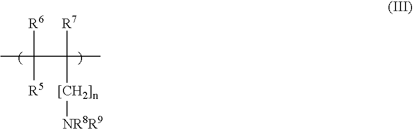
where
R⁵ to R⁹, independently of one another, are hydrogen, C₁-C₆-alkyl, -aryl or -alkylaryl or R⁸ and R⁹ together with the nitrogen atom to which they are bonded can form a 5 to 8-membered N-heterocycle and
n is 0,1,2,3 or 4,
where the weight ratio of the sum of the monomer building blocks of polymer i) carrying the amide groups to the sum of the monomer building blocks of polymer ii) carrying the amino groups is in the range from less than 27:1 to 1:30,
with the proviso that i) comprises less than 0.49% by weight of acrolein, based on the total weight of i) in copolymerized and/or grafted form and
with the proviso that the degree of hydrolysis is greater than 75 if polymer ii) is obtained by hydrolysis of polyvinylformamide.

38. A method of producing detergents and cleaners, wound coverings or crop protection compositions or recovering oil in enhanced oil recovery processes utilizing the mixture of claim 37.

39. The thickening water-containing composition according to claim 21, where polymer i) comprises (meth)acrylamide and/or N-vinyllactams in copolymerized form.
